(19) United States
(12) Patent Application Publication
(10) Pub. No.: US 2015/0288841 A1
(43) Pub. Date: Oct. 8, 2015

(54) MULTI-FUNCTIONAL PERIPHERAL AND FILE TRANSMITTING METHOD

(71) Applicant: Sharp Kabushiki Kaisha, Osaka (JP)

(72) Inventor: Yuki SHIBAYAMA, Osaka-shi (JP)

(21) Appl. No.: 14/675,783

(22) Filed: Apr. 1, 2015

(30) Foreign Application Priority Data
Apr. 7, 2014 (JP) 2014-078486

(51) Int. Cl. H04N 1/00

(52) U.S. Cl. CPC H04N 1/00957; H04N 1/00278

(57) ABSTRACT

Provided is a multi-functional peripheral capable of, even when the numbers of pages of plural document sets are different, transmitting plural files obtained by reading each of the plural document sets by a document reading portion to one destination by single communication. The multi-functional peripheral includes a document reading portion, a transmitting portion (a transmission processing portion and a communication portion) that transmits an electronic mail, and a setting portion that sets the multi-functional peripheral to a predetermined transmission mode based on user operation. When the multi-functional peripheral is set to the predetermined transmission mode, the transmitting portion transmits plural files corresponding to plural document sets respectively, which are obtained by executing reading at the document reading portion for the plural document sets prepared by allowing the numbers of pages to be different individually with attached to one electronic mail.

### CROSS-NOTING PARAGRAPH

This non-provisional application claims priority under 35 U.S.C. §119(a) on Patent Application No. 2014-078486 filed in JAPAN on Apr. 7, 2014, the entire contents of which are hereby incorporated herein by reference.

### FIELD OF THE INVENTION

The present invention relates to a multi-functional peripheral and a file transmitting method in the multi-functional peripheral.

### BACKGROUND OF THE INVENTION

Conventionally, some multi-functional peripherals are capable of transmitting an electronic mail by a function of performing processing for transmitting scanned image data by an E-mail (electronic mail) (hereinafter, referred to as Scan to E-mail) or an Internet FAX function.

In the electronic mail transmission processing in such a multi-functional peripheral, plural sheets of documents are read by a scanner at a time, the read data is made into one image file, and this one image file is transmitted by attaching to an electronic mail (for example, refer to Japanese Laid-Open Patent Publication No. 2011-135420). A format of this image file includes a TIFF (Tagged Image File Format), a PDF (Portable Document Format) or the like.

In a conventional technology including the technology described in Japanese Laid-Open Patent Publication No. 2011-135420, however, when plural materials (document set) that the numbers of pages are same or different are transmitted to one destination, it is necessary to select a destination and setting content again for each document set and perform transmission operation plural times. That is, in the conventional multi-functional peripheral, when plural files that the numbers of pages are same or different are transmitted to the same destination, transmission operation needs to be performed plural times, which is troublesome.

Note that, when a function of fling for each of predetermined number of pages is used, image data which is scanned at a time is able to be made into plural files and transmitted, but the number of pages of each file is fixed, so that it is impossible to deal with simultaneous transmission of plural document sets having the arbitrary number of pages.

### SUMMARY OF THE INVENTION

An object of the present invention is to provide a multi-functional peripheral capable of, even when the numbers of pages of plural document sets are different, transmitting plural files obtained by reading each of the plural document sets by a document reading portion to one destination by single communication, and a file transmitting method in the multi-functional peripheral.

An object of the present invention is to provide a multi-functional peripheral, comprising a document reading portion, and a transmitting portion that transmits an electronic mail, wherein, a setting portion that sets the multi-functional peripheral to a predetermined transmission mode based on user operation is further included, the transmitting portion, when the multi-functional peripheral is set to the predetermined transmission mode, transmits plural files corresponding to plural document sets respectively which are obtained by executing reading at the document reading portion for the plural document sets prepared by allowing the numbers of pages to be different individually by attaching to one electronic mail.

Another object of the present invention is to provide the multi-functional peripheral, further comprising: a section recognizing portion that, when the multi-functional peripheral is set to the predetermined transmission mode, recognizes a page section between the document sets which are subjected to user designation as to a document bundle composed of the plural document sets; and a page dividing portion that generates the plural files so as to correspond to the plural document sets respectively based on the page section recognized by the section recognizing portion from image data obtained by reading of the document bundle at the document reading portion.

Another object of the present invention is to provide the multi-functional peripheral, further comprising: a display portion that, when the multi-functional peripheral is set to the predetermined transmission mode, displays a user interface image for prompting reading of a next of the document sets for each reading of the document sets until reading of the document bundle is finished at the document reading portion, wherein the user designation is a designation by performing reading operation after sectioning for each of the document sets in accordance with the user interface image.

Another object of the present invention is to provide the multi-functional peripheral, wherein the user designation is a designation by changing sizes of document sheets between the document sets which are consecutive, and when the multi-functional peripheral is set to the predetermined transmission mode, the section recognizing portion causes the document reading portion to read the document bundle successively to obtain the image data, detects a difference between the sizes from the image data, and recognizes a site where the difference between the sizes occurs as the page section.

Another object of the present invention is to provide the multi-functional peripheral, wherein the user designation is a designation by changing placement directions of document sheets between the document sets which are consecutive, and when the multi-functional peripheral is set to the predetermined transmission mode, the section recognizing portion causes the document reading portion to read the document bundle successively to obtain the image data, detects the placement directions from the image data, and recognizes a site where a difference between the placement directions occurs as the page section.

Another object of the present invention is to provide the multi-functional peripheral, further comprising: a display portion that, when the multi-functional peripheral is set to the predetermined transmission mode, displays a user interface image for causing a user to input the number of sets of the document sets included in the document bundle and the number of pages of each of the document sets, wherein the user designation is a designation by inputting the number of sets and the number of pages in a state where the user interface image is displayed.

Another object of the present invention is to provide the multi-functional peripheral, wherein the user designation is a designation by putting a predetermined-color sheet additionally between the document sets, and when the multi-functional peripheral is set to the predetermined transmission mode, the section recognizing portion causes the document reading portion to read the document bundle successively to obtain the image data, detects the predetermined-color sheet from the image data, and recognizes a position of the predetermined-color sheet as the page section.

Another object of the present invention is to provide the multi-functional peripheral, further comprising: a reservation setting portion that sets a reservation of time and date when transmission processing for transmitting a file obtained by reading at the document reading portion by attaching to an electronic mail is executed by the transmitting portion, wherein when the multi-functional peripheral is set to the predetermined transmission mode and when a different file obtained by reading at the document reading portion is transmitted to a destination same as a destination of a transmission-reserved file which is the file serving as a target of the transmission processing, the transmitting portion transmits the transmission-reserved file and the different file by attaching to the one electronic mail.

Another object of the present invention is to provide a file transmitting method in a multi-functional peripheral including a document reading portion and a transmitting portion that transmits an electronic mail, including: a step that a setting portion of the multi-functional peripheral sets the multi-functional peripheral to a predetermined transmission mode based on user operation, a step that, when the multi-functional peripheral is set to the predetermined transmission mode, the transmitting portion transmits plural files corresponding to plural document sets respectively which are obtained by executing reading at the document reading portion for the plural document sets prepared by allowing the numbers of pages to be different individually by attaching to one electronic mail.

### BRIEF DESCRIPTION OF THE DRAWINGS

FIG. 1 is a block diagram showing one configuration example of a multi-functional peripheral according to a first embodiment of the present invention;

FIG. 2 is an external view showing one example of an operation portion in the multi-functional peripheral of FIG. 1;

FIG. 3 is a block diagram showing one configuration example of a multi-functional peripheral according to a second embodiment of the present invention;

FIG. 4 is a flowchart for explaining a first processing example executed with a Scan to E-mail function in the multi-functional peripheral of FIG. 3;

FIG. 5A is a flowchart subsequent to FIG. 4;

FIG. 5B is a flowchart subsequent to FIG. 5A;

FIG. 6A is a view showing one example of a UI image which is displayed when an E-mail function is selected from a UI image of FIG. 2 in the multi-functional peripheral of FIG. 3;

FIG. 6B is a view showing one example of a UI image which is displayed when other function is selected in the UI image of FIG. 6A;

FIG. 7A is a view showing one example of a UI image which is displayed in document reading processing from an ADF of FIG. 5A;

FIG. 7B is a view showing one example of a UI image which is displayed in document reading processing from a document platen of FIG. 5B;

FIG. 8 is a flowchart of a second processing example subsequent to FIG. 4;

FIG. 9A is a flowchart of a third processing example subsequent to FIG. 4;

FIG. 9B is a flowchart subsequent to FIG. 9A;

FIG. 10A is a flowchart for explaining a fourth processing example executed with the Scan to E-mail function in the multi-functional peripheral of FIG. 3;

FIG. 10B is a flowchart subsequent to FIG. 10A;

FIG. 10C is a flowchart subsequent to FIG. 10B;

FIG. 11A is a view showing one example of a UI image which is displayed when a plural-file transmit key is selected in the UI image of FIG. 6B;

FIG. 11B is a view showing an input example different from FIG. 11A;

FIG. 12 is a flowchart of a fifth processing example subsequent to FIG. 4;

FIG. 13 is a block diagram showing one configuration example of an MFP according to a third embodiment of the present invention;

FIG. 14 is a flowchart for explaining a processing example executed with an Internet FAX function in the multi-functional peripheral of FIG. 13; and

FIG. 15 is a view showing one example of a UI image which is displayed in the processing of FIG. 14 in the multi-functional peripheral of FIG. 13.

### PREFERRED EMBODIMENTS OF THE INVENTION

A multi-functional peripheral according to the present invention is equipment having at least a document reading function (scanner function) and an electronic mail transmitting function, and transmits a file of an image which is read, thus may be said as an image transmitting apparatus. The electronic mail transmitting function is included in an Internet facsimile (Internet FAX) function and a Scan to E-mail function. The multi-functional peripheral according to the present invention is able to have, for example, a copy function, a printer function, a facsimile function and the like in addition thereto. Description will hereinafter be given for various embodiments of the multi-functional peripheral according to the present invention with reference to the drawings.

### First Embodiment

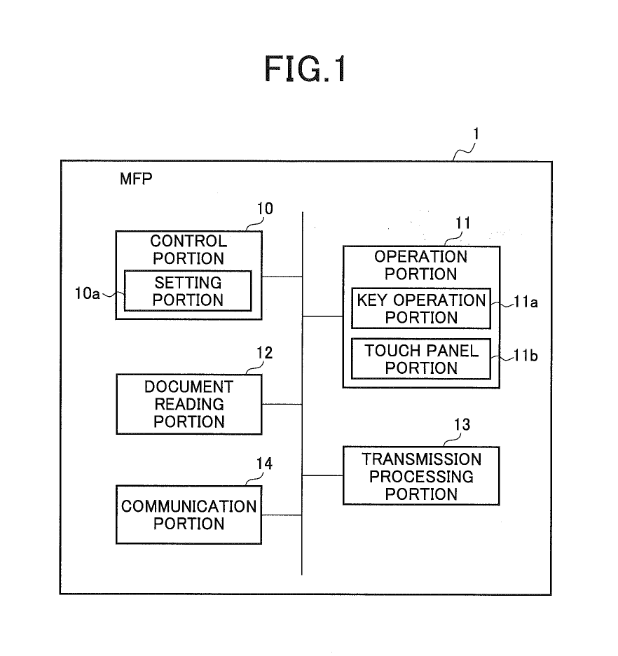

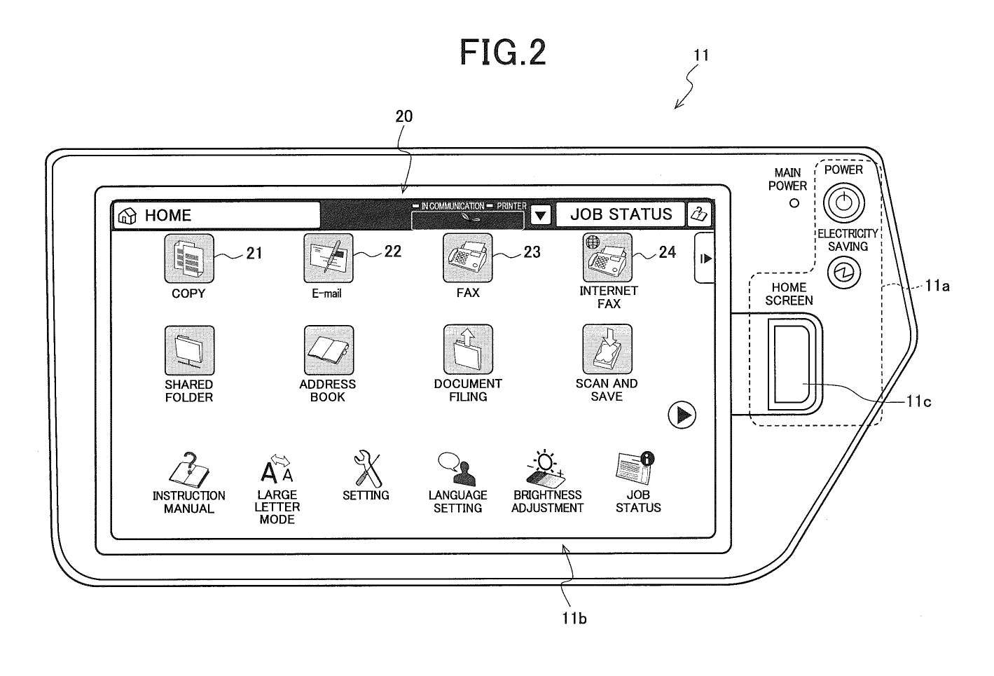

Description will be given for a first embodiment of the present invention with reference to FIG. 1. FIG. 1 is a block diagram showing one configuration example of the multi-functional peripheral (MFP) according to the present embodiment, and FIG. 2 is an external view showing one example of an operation portion in the MFP of FIG. 1.

The MFP 1 according to the present embodiment includes a document reading portion 12 that optically reads an image of a document, and a transmitting portion that transmits an electronic mail with a file attached (mail transmitting portion). In addition, the MFP 1 includes a control portion 10 that controls the entire MFP 1 and an operation portion 11 that receives operation input from a user.

The document reading portion 12 is apart which is provided on a lower face of a document platen on which a document (sheet) to be read is placed for optically reading a document image on the sheet placed on the document platen, and is also referred to as a scanner portion. Further, the MFP 1 is also able to be provided with an ADF (Automatic Document Feeder) on the document platen. The ADF is a device for automatically conveying a document and an image of the document which is conveyed automatically is to be read by the document reading portion 12. Of course, the document reading portion 12 may be provided in the ADF additionally. Here, the ADF also includes a device referred to as an SPF (Single Pass Feeder), an RSPF (Reversing Single Pass Feeder), etc.

The above transmitting portion is exemplified by a transmission processing portion 13 and a communication portion 14. The communication portion 14 is a communication interface which is connected to, for example, a LAN (Local Area Network) and performs communication of electronic mail data and communication of Internet FAX via the Internet. The Internet FAX is for transmitting and receiving a file showing transmission and reception contents by attaching to an electronic mail. The transmission processing portion 13 is a part which creates an electronic mail to be transmitted and performs transmission processing via the communication portion 14.

The control portion 10 stores a control program (firmware) for controlling the entire MFP 1 in a program saving area and operates the control program to thereby perform various control. For example, the control portion 10 is able to be configured by control devices such as a CPU (Central Processing Unit) or an MPU (Micro Processing Unit), a RAM (Random Access Memory) as a working area, and a storage device in which the above control program and various setting contents are stored, and is also able to be mounted as an integrated-circuit/IC chip set. As this storage device, a flash ROM (Read Only Memory), an EEPROM (Electrically Erasable and Programmable ROM), an HDD (Hard Disk Drive) or the like is cited, and a storage portion such as an HDD for saving an image (not shown) is also usable.

The operation portion 11 has a key operation portion 11a and a touch panel portion 11b as exemplified in FIG. 2. A user is allowed to input a setting value or the like or execute processing from the operation portion 11 when using the MFP 1.

The key operation portion 11a is a hardware key for receiving user operation, and an example that a power key, an electricity saving key, a shift key to a home screen (home shift key) 11c are provided is taken in FIG. 2, but, without limitation thereto, other keys such as a start key for starting a copy and a numeric key group for inputting numbers may be provided.

The touch panel portion 11b is composed of a display portion such as a liquid crystal display or an organic electroluminescence display, and a touch sensor portion that detects touch operation by the user on a display area of the display portion. Examples of the sensor provided as the touch sensor portion include an electrostatic capacitance type sensor and a resistance film type sensor.

A UI (User Interface) image is displayed on this display portion, and when touching is detected by the touch sensor portion to the displayed UI image, processing shown by an image in the UI image corresponding to the touched position is executed as well as transition of the UI image is carried out as necessary. An example of the UI image to be displayed on an initial screen includes a UI image 20 shown in FIG. 2.

In the UI image 20, keys for using functions provided in the MFP 1, such as a copy function select key (copy mode select key) 21, an E-mail function select key 22, a FAX function select key 23, an Internet FAX function select key 24, are displayed so as to be selectable by the user. Note that, for example, like the home shift key 11c, it is possible to configure so that transition of the UI image or the like is allowed also by operation of pressing a hardware key. Further, in order to use functions selected by the copy mode select key 21 and the FAX function select key 23, the MFP 1 may include a printing portion, and a FAX communication portion which transmits and receives a FAX image via a telephone line or the like, which are not shown.

The MFP 1 further includes a setting portion 10a which sets the MFP 1 to a predetermined transmission mode based on user operation. The above predetermined transmission mode refers to a mode for executing processing content described below. In FIG. 1, an example is taken that the setting portion 10a is provided in the control portion 10 for inputting user operation from the operation portion 11 to execute setting. Of course, the setting portion 10a may be provided outside the control portion 10.

When the MFP 1 is set to the above predetermined transmission mode, the transmission processing portion 13 generates plural files corresponding to plural document sets respectively, which are obtained by executing reading at the document reading portion 12 for the above plural document sets prepared by allowing the numbers of pages to be different individually. The files may be generated in, for example, a PDF or TIFF format. As explained in an embodiment described below, the above plural document sets may be or may not be a document bundle which is to be read at a time.

Then, the transmission processing portion 13 attaches these plural files to one electronic mail to transmit to a destination of this electronic mail via the communication portion 14. Note that, the destination may be received by the operation portion 11 before the transmission.

In other words, the above predetermined transmission mode indicates a mode in which plural document sets (the numbers of pages of each of the document sets may be different) exist and plural files corresponding to the plural document sets respectively is transmitted by one electronic mail (hereinafter, referred to as a plural-file transmission mode). Moreover, the plural-file (multifile) transmission mode may be also said as a mode in which a document bundle is read separately plural times to be transmitted being separated by one electronic mail. For example, when a key for selecting the plural-file transmission mode is displayed in a UI image after the E-mail function select key 22 has been selected or a UI image after the Internet FAX function select key 24 has been selected, the user is allowed to select the plural-file transmission mode.

With the processing as described above, the MFP 1 according to the present embodiment is able to transmit plural files obtained by scanning each of plural document sets that the numbers of pages are different (or plural document sets that the numbers of pages are the same) to one destination by single communication. Accordingly, a receiver who has received Internet FAX communication with such plural files attached by an information processing apparatus such as a PC (personal computer) is allowed to execute printing for each file by a connected printer, that is, to execute so-called “chapter division” printing. Of course, as usual, a receiver who has received this Internet FAX communication by a FAX apparatus is to perform printing of a document bundle in which plural document sets are in series. Further, a receiver who has received transmission of such an E-mail with plural files attached by an information processing apparatus such as a PC is also allowed to execute printing for each file in the same manner.

### Second Embodiment

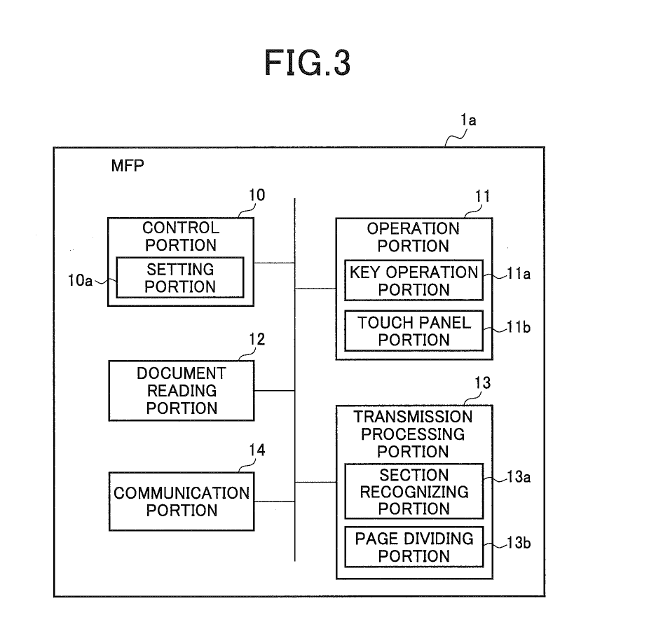

Description will be given for a second embodiment of the present invention with reference to FIG. 3. FIG. 3 is a block diagram showing one configuration example of an MFP according to the present embodiment. The MFP according to the present embodiment is specialized in that plural document sets corresponding to each of plural files to be attached in the first embodiment are all read by the document reading portion 12 at the same time. Description will be given below for the present embodiment, but description for same points as the first embodiment will be omitted.

As exemplified in FIG. 3, in an MFP 1a according to the present embodiment, the transmission processing portion 13 in the MFP 1 of FIG. 1 has a section recognizing portion 13a and a page dividing portion 13b. When the MFP 1a is set to the plural-file transmission mode, the section recognizing portion 13a recognizes, as to a document bundle composed of plural document sets to be read by the document reading portion 12, a page section between the document sets, which is subjected to user designation. Note that, the page section may exist at two or more sites without limitation to one site.

The above user designation is able to be received by allowing the numbers of pages to be different in each of the document sets, as described in the first embodiment. That is, as the page section, the section recognizing portion 13a is able to recognize a page section such that the numbers of pages become different between the former and latter sets, and may be said to have capability of recognizing such a page section.

The page dividing portion 13b generates the above plural files so as to correspond to the above plural document sets respectively from image data obtained by reading of the document bundle at the document reading portion 12 based on the page section recognized by the section recognizing portion 13a. The transmission processing portion 13 then transmits the plural files generated by the page dividing portion 13b by attaching to one electronic mail via the communication portion 14.

With the processing as described above, as to a document bundle composed of plural document sets that the numbers of pages are different (or plural document sets that the numbers of pages are the same), the MFP 1a according to the present embodiment is able to transmit plural files obtained by scanning each of the document sets at the same time to one destination by single communication.

Description will be given below for various processing examples applicable in the present embodiment with a case where the Scan to E-mail function is used and a case where the Internet Fax function is used.

### First Processing Example

Description will be given for a first processing example in the MFP 1a according to the present embodiment. In the present processing example, it is set that a document bundle composed of plural document sets corresponding to each of plural files to be attached is read by the document reading portion 12 not at a time but separately plural times (by the number of the document sets).

The MFP 1a in the present processing example includes a display portion that, when the MFP 1a is set to the plural-file transmission mode, displays a UI image for prompting reading of a next document set for each reading of a document set until reading of the document bundle is finished at the document reading portion 12 (referred to as a first UI image for convenience). This display portion is able to be exemplified by the display portion in the touch panel portion 11b. Further, the above user designation in the present processing example is designation by performing reading operation after sectioning for each document set in accordance with the first UI image, and the section recognizing portion 13a recognizes a section subjected to the user designation.

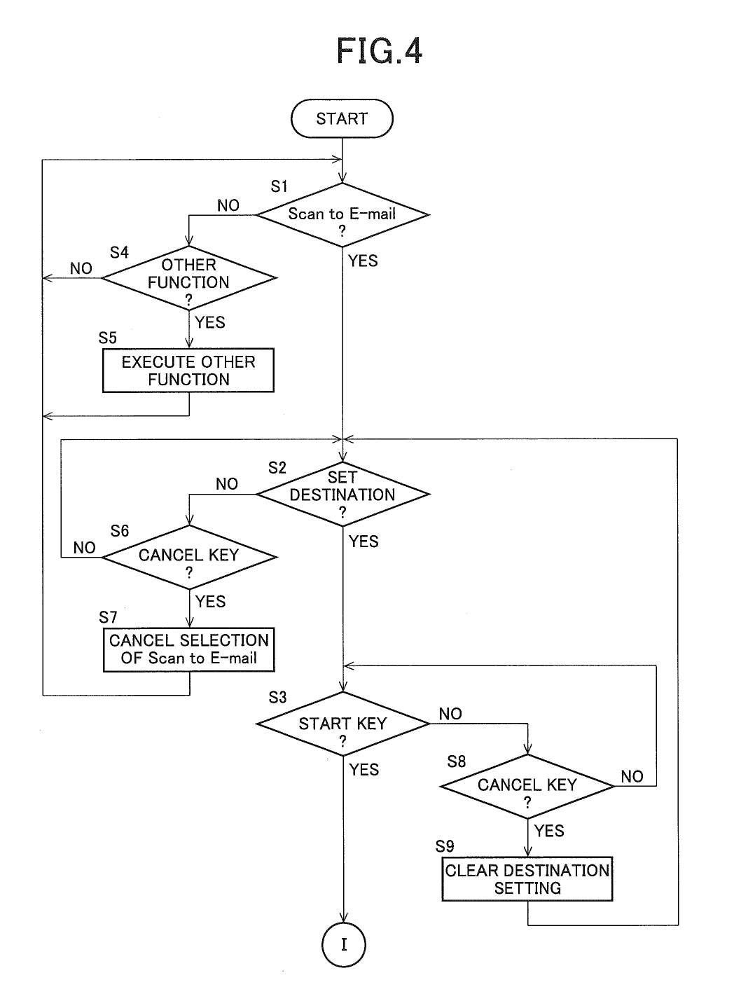

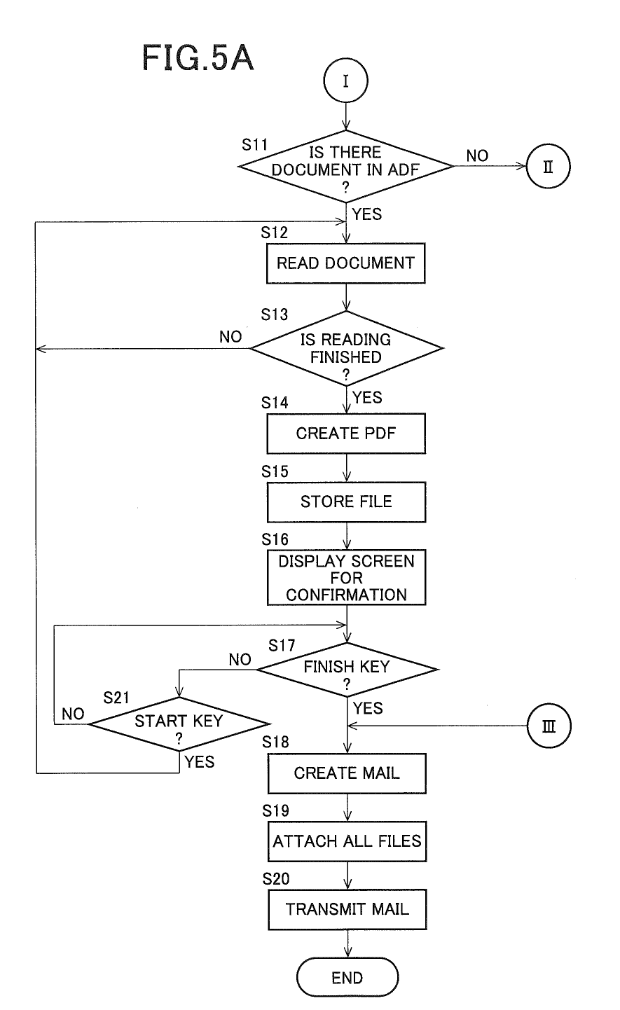

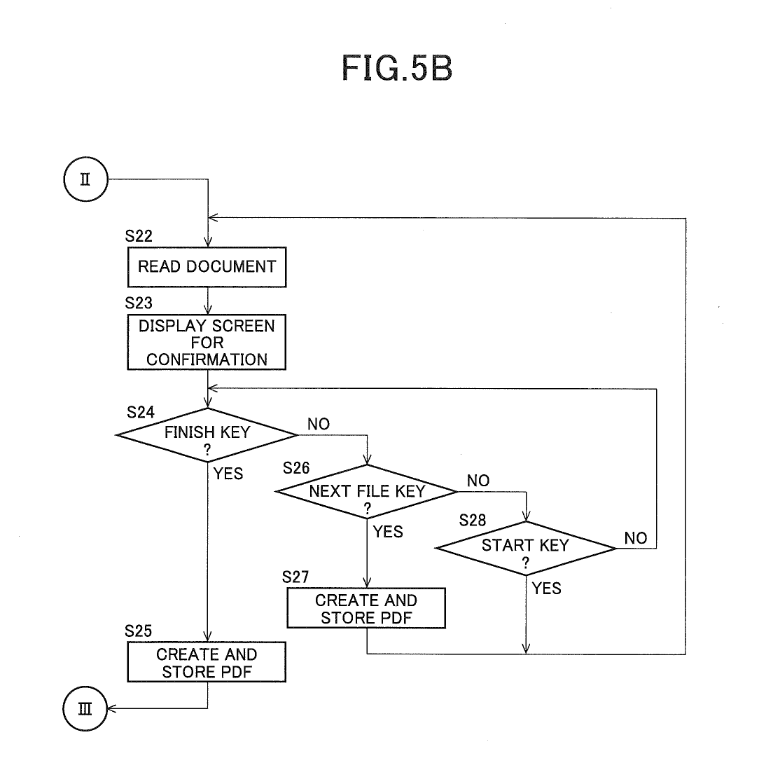

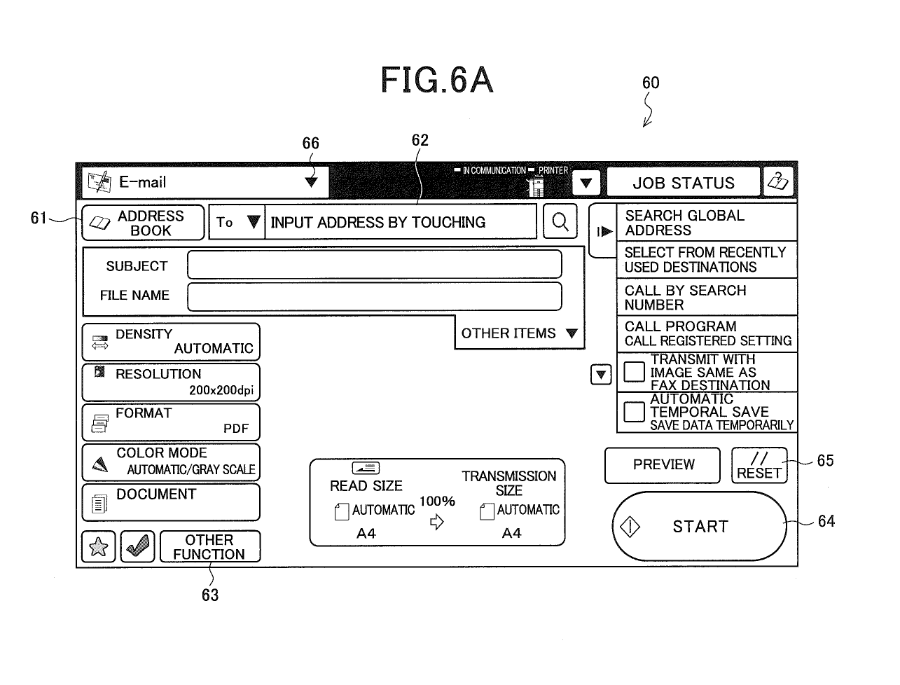

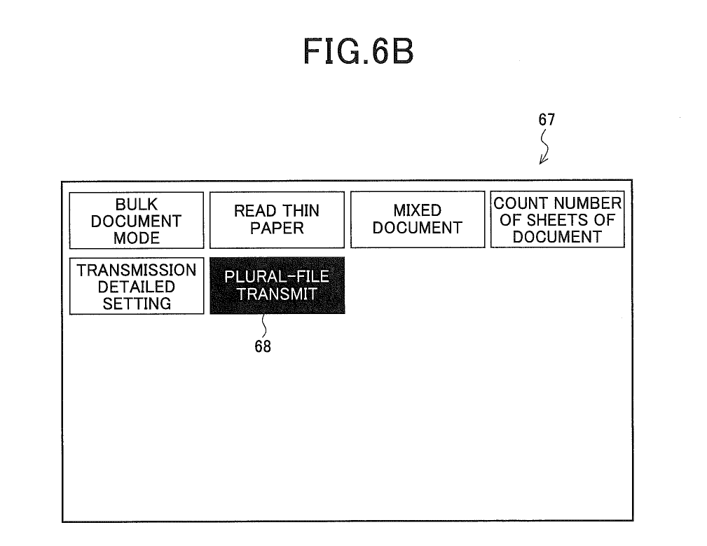

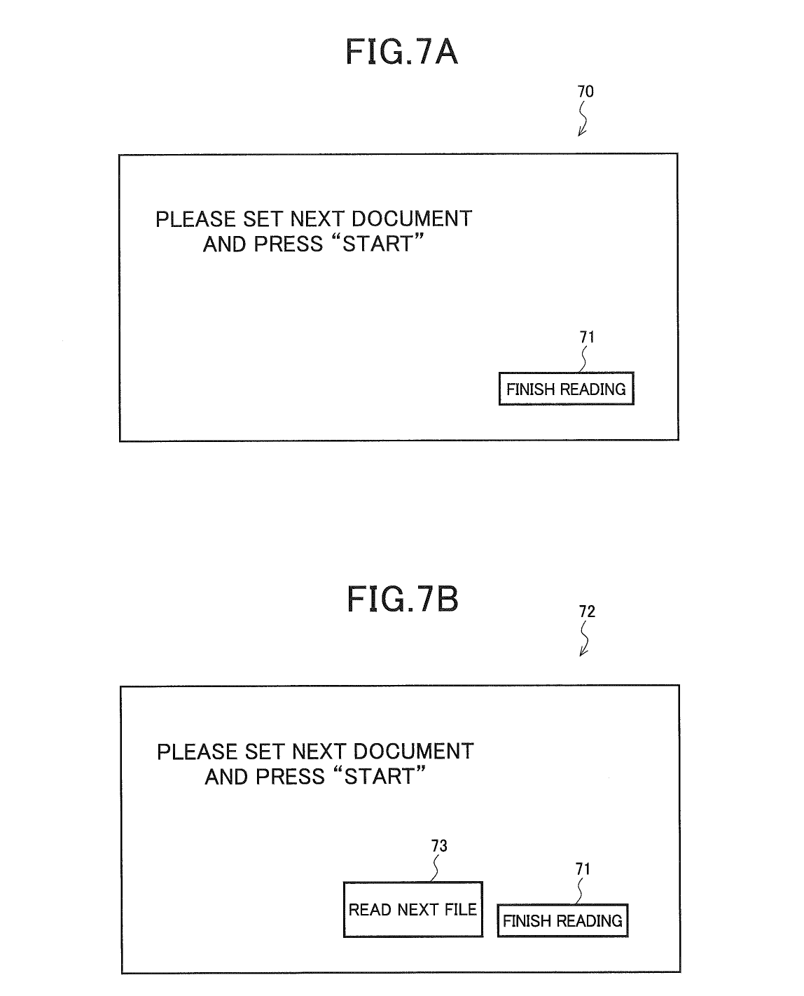

The present processing example will be described with a case where the Scan to E-mail function is used with reference to FIG. 4 to FIG. 7B in combination. FIG. 4 is a flowchart for explaining the first processing example executed with the Scan to E-mail function in the MFP of FIG. 3, FIG. 5A is a flowchart subsequent to FIG. 4, and FIG. 5B is a flowchart subsequent to FIG. 5A. Further, FIG. 6A is a view showing one example of a UI image which is displayed when the E-mail function is selected from the UI image of FIG. 2 in the MFP of FIG. 3, and FIG. 6B is a view showing one example of a UI image which is displayed when other function is selected in the UI image of FIG. 6A. Furthermore, FIG. 7A is a view showing one example of a UI image which is displayed in document reading processing from the ADF of FIG. 5A, and FIG. 7B is a view showing one example of a UI image which is displayed in document reading processing from the document platen of FIG. 5B.

Note that, when description is omitted in other processing examples including the present processing example as well, user operation is performed from the key operation portion 11a or the touch panel portion 11b and a UI image is displayed on the touch panel portion 11b under control from the control portion 10.

First, when the E-mail function select key 22 is selected by the user in the UI image 20 of FIG. 2, a UI image 60 exemplified in FIG. 6A is displayed. In the UI image 60, an address book key 61 for causing an address book to be displayed to select a destination, a destination input field 62 for displaying a software keyboard to directly input a destination, an other function key 63, a start key 64, a reset key 65, a function change pull-down menu 66 and the like are displayed.

When the other function key 63 is selected by the user among them, a UI image 67 exemplified in FIG. 6B is displayed instead of the UI image 60 or being overlapped on the UI image 60. A list of other functions is displayed in the UI image 67, in which a plural-file transmit key 68 is also included.

When the plural-file transmit key 68 is selected by the user, the setting portion 10a sets the MFP 1a to the plural-file transmission mode and the UI image 60 is displayed again. After such setting, processing of Scan to Email is executed with procedure which starts from FIG. 4.

First, the control portion 10 judges whether or not to be the Scan to E-mail function (step S1). In the case of NO at step S1, the control portion 10 judges whether or not to be the other function (step S4). At step S4, whether a function other than the Scan to Email function (also simply referred to as an E-mail function) is set by the function change pull-down menu 66, or whether the home shift key 11c is selected to provide a state where any function is not selected is judged. In the case of YES at step S4, the control portion 10 executes the function (step S5) and returns to step S1, and in the case of NO at step S4, returns to step S1 directly to wait for selection of the E-mail function.

In the case of YES at step S1, the control portion 10 judges whether or not a destination is set (step S2), and in the case of NO, judges whether or not a cancel key (the reset key 65 or the home shift key 11c) is selected (step S6). In the case of NO at step S6, the control portion 10 returns to step S2, and in the case of YES at step S6, cancels the E-mail function (step S7) and returns to step S1.

In the case of YES at step S2, the control portion 10 judges whether or not the start key 64 is selected (step S3), and in the case of NO, judges whether or not the cancel key (reset key 65) is selected (step S8). In the case of NO at step S8, the control portion 10 returns to step S3 to wait for pressing of the start key 64, while in the case of YES at step S8, clears destination setting (step S9) and returns to step S2.

In the case of YES at step S3, processing of FIG. 5A and FIG. 5B is executed. First, the control portion 10 judges whether or not there is a document in the ADF based on a detection result from a not-shown document detection sensor (step S11), and in the case of YES, causes the document reading portion 12 to execute document reading processing while conveying the document by the ADF automatically (step S12). Based on the detection result from the above document detection sensor, the document reading portion 12 judges whether or not all reading is finished, that is, no document exists in the ADF (step S13) and continues the document reading processing of step S12 until YES is given. Thereby, reading of one document set placed in the ADF by the user is completed.

When YES is given at step S13, the section recognizing portion 13a judges that reading of the current document set is finished. Then, the page dividing portion 13b divides (extracts) image data corresponding to the one document set from image data read by the document reading portion 12 and generates (creates) one file such as a PDF file (step S14) for storing the file (step S15). Note that, the image data read by the document reading portion 12 is accumulated successively in a buffer which is provided in the transmission processing portion 13 (or provided separately). Further, one which is filed is to be stored in a saving area which is similarly provided in the transmission processing portion 13 (or provided separately).

After step S15, a UI image 70 of FIG. 7A is displayed (step S16). In the UI image 70, with a message for prompting the user to place a next document set and press the start key 64, a finish reading key 71 which is selected when finishing document riding processing is displayed. The control portion 10 judges whether or not the finish reading key 71 is selected (step S17), and in the case of NO at step S17, judges whether or not the start key 64 is selected (step S21), while in the case of NO here, returns to step S17 to wait for selection.

In the case of YES at step S21, which means that the user has placed the next document set in the ADF and pressed the start key 64, the control portion 10 returns to step S12 to execute similar document reading processing for the document set.

In the case of YES at step S17, the transmission processing portion 13 creates one electronic mail to the destination which is set at step S2 (step S18), attaches all files which are stored at the time to the electronic mail (step S19), performs transmission of the electronic mail via the communication portion 14 (step S20), and finishes the processing. In the E-mail function, inputting of a text of the electronic mail may be allowed, and therefore the inputting of the text may be received before the processing of step S18. Note that, if never going through the case where YES is given at step S21 or step S26 which is described below, only one file is to be attached and transmitted even in the plural-file transmission mode at step S19.

In the case of NO at step S11, which means that a document is placed on the document platen, document reading processing on the document platen as shown in FIG. 5B is executed. Note that, when it is not placed even on the document platen, a message for prompting placement of a document may be displayed.

First, the control portion 10 causes the document reading portion 12 to execute document reading processing from the document platen (step S22). Subsequently, a UI image 72 of FIG. 7B is displayed (step S23). In the UI image 72, with a message for prompting the user to place a next document and press the start key 64, the finish reading key 71 which is selected when finishing document reading processing and a read next file key (referred to as a next file key) 73 which is selected when a document is read as a next file are displayed.

The control portion 10 judges whether or not the finish reading key 71 is selected (step S24), and in the case of NO at step S24, judges whether or not the next file key 73 is selected (step S26), and in the case of NO at step S26, judges whether or not the start key 64 is selected (step S28).

In the case of YES at step S28, which means that the user has placed the next document on the document platen and pressed the start key 64, the control portion 10 returns to step S22 to execute similar document reading processing for the document. By repeating placing of a document included in one document set on the document platen and pressing of the start key 64 in this manner, the user executes reading of one document set. In the case of NO at step S28, the procedure returns to step S24.

In the case of YES at step S26, the section recognizing portion 13a judges that reading of the current document set is finished. Then, the page dividing portion 13b divides image data corresponding to the one document set from image data read by the document reading portion 12 and creates and stores one file (such as a PDF file) (step S27). After step S27, reading of a next document set is executed by returning to step S22.

Further, in the case of YES at step S24 as well, the page dividing portion 13b divides image data corresponding to the one document set from image data read by the document reading portion 12 (extracts remaining image data) and creates and stores one file (such as a PDF file) (step S25).

Then, after step S25, by moving to step S18, all files that has been stored so far are attached to one electronic mail and the electronic mail is transmitted. In this manner, as to the reading processing from the document platen, the document reading processing for the document set is executed until the next file key 73 is pressed, and after filing at a stage where the next file key 73 is pressed, processing for reading and filing a next document set is executed. Then, the processing for reading and filing the next document set is executed until the finish reading key 71 is pressed.

As described above, in the present processing example, while making inquiries like in the UI image 70 and the UI image 72 for each document set, reading of a document bundle is executed separately plural times (for each document set), and one electronic mail with all files attached is transmitted finally. For example, when it is desired to transmit three copies (three sets) of document sets having different contents, three files are generated and transmitted by attaching to one electronic mail.

Note that, though a file name or a subject of an electronic mail is not referred to, as to the file name, for example, a file name which is input from the file name input field of the UI image 60, when plural document sets exist, a branch number may be added to a corresponding file in turn. When even the file name is not input, an arbitral sequentially-numbered file name may be added, while when plural files exist, branch numbers may be added thereto. Further, as to the subject of the electronic mail, for example, one which is input from a subject input field of the UI image 60 may be used, and when there is no input of the subject, a subject may not be given or an arbitral sequentially-numbered subject may be added. As to the file name and the subject of the electronic mail, the same is also applied to other processing examples described below. Further, without limitation to the present processing example, though description for a case where the Internet FAX function is used will be omitted, description is able to be given basically with a same concept also in the processing examples described below.

### Second Processing Example

Description will be given for a second processing example in the MFP 1a according to the present embodiment. The present processing example is characterized in that a document bundle composed of plural document sets corresponding to each of plural files to be attached is read by the document reading portion 12 basically at a time and sheet sizes of documents are differentiated. Description will be given below for the present processing example, but description for same points as the first processing example will be omitted.

In the present processing example, the above user designation is designation by changing a sheet size of a document in the consecutive document sets. When the MFP 1a is set to the plural-file transmission mode, the section recognizing portion 13a then causes the document reading portion 12 to read the document bundle successively to obtain image data, detects a difference between sizes from the image data, and recognizes a site where the size difference occurs as a page section. The page dividing portion 13b divides the image data obtained by reading of the document bundle at the document reading portion 12 based on the page section recognized by the section recognizing portion 13a, and generates plural files so as to correspond to the plural document sets respectively included in the document bundle.

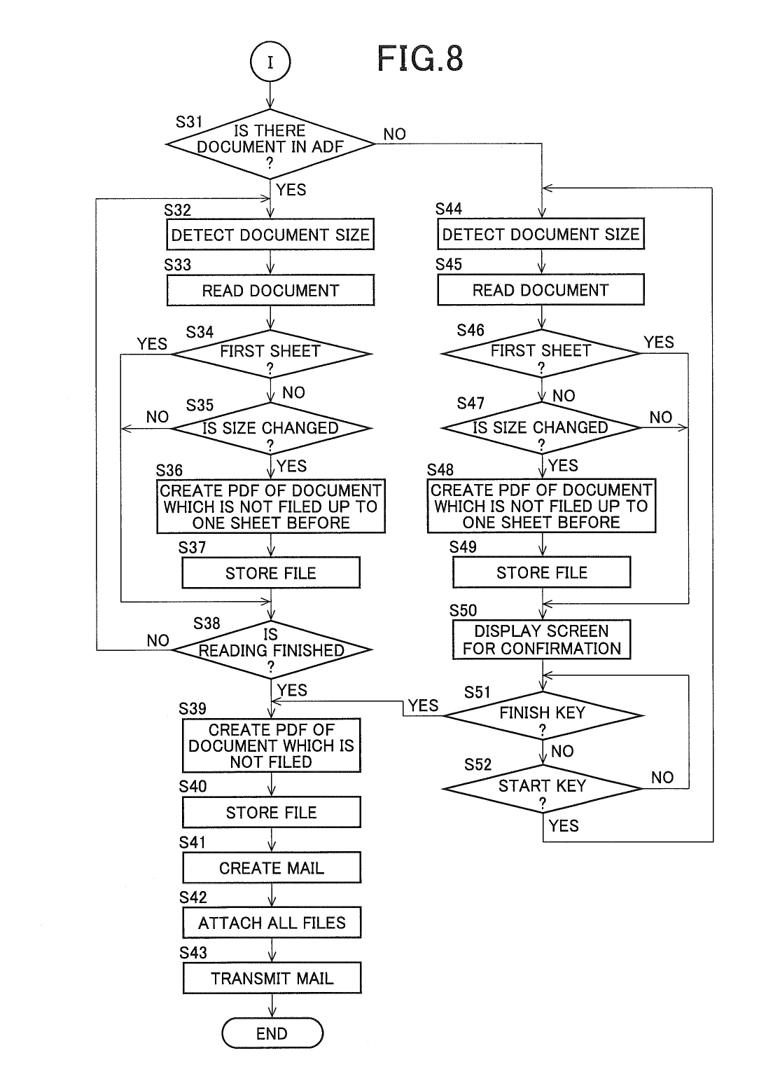

The present processing example will be described with a case where the Scan to E-mail function is used with reference to FIG. 8 in combination. FIG. 8 is a flowchart of the present processing example subsequent to FIG. 4. In the present processing example, in the case of YES at step S3 of FIG. 4, processing of FIG. 8 is executed.

First, the control portion 10 judges whether or not there is a document in the ADF based on a detection result from the not-shown document detection sensor (step S31), and in the case of YES, detects a sheet size of the document (step S32). Step S32 is able to be realized by arranging plural document detection sensors in place. Subsequently, the control portion 10 causes the document reading portion 12 to execute document reading processing while carrying the document by the ADF automatically (step S33).

Then, the section recognizing portion 13a judges whether or not to be a first document sheet (step S34), and in the case of YES, the procedure moves to step S38. Note that, though an example that only a single side of the document sheet is a reading target is taken in this example, when double sides are targets, the above judgment may be for judging whether or not to be a first page. Without limitation to the present processing example, description is given basically on the premise of only a single side in other processing examples as well, while in the case of double sides, description is able to be given by substituting a “sheet” with a “page”.

At step S38, the document reading portion 12 judges whether or not all reading is finished based on a detection result from the document detection sensor. In the case of NO at step S38, the procedure returns to step S32. In the case of NO at step S34, the section recognizing portion 13a judges whether or not size change is performed based on the detection result at step S32 (step S35), and in the case of NO, the procedure moves to step S38.

In the case of YES at step S35, the section recognizing portion 13a judges that reading of the current document set is finished. Then, the page dividing portion 13b creates one file (such as PDF) from image data of a document set which is not filed up to one sheet before (step S36) for storing (step S37). After step S37, the procedure moves to step S38. In the case of YES at step S38, the page dividing portion 13b creates one file from the image data which is not filed at the time (step S39) for storing (step S40).

Subsequently, the transmission processing portion 13 creates one electronic mail to the destination which is set at step S2 (step S41), attaches all files which are stored to the electronic mail (step S42), performs transmission of the electronic mail via the communication portion 14 (step S43), and finishes the processing. Note that, if never going through the case where YES is given at step S35 or step S47 which is described below, only one file is to be attached and transmitted even in the plural-file transmission mode at step S42.

Note that, when a UI image for confirming whether or not reading is finished (reading of a next document set is performed) like the UI image 70 of FIG. 7A is to be displayed immediately after the case of YES at step S38, it is possible to perform reading by the ADF separately plural times like in the first processing example. In this case, a target to be read at a time each time the start key 64 is pressed may be a document set group which is accompanied by size change or one document set which is not accompanied by size change.

In the case of NO at step S31, which means that a document is placed on the document platen, the control portion 10 detects a sheet size of the document on the document platen (step S44). Subsequently, the control portion 10 causes the document reading portion 12 to read the document on the document platen (step S45). Then, the section recognizing portion 13a judges whether or not to be a first document sheet (step S46).

In the case of YES at step S47, the section recognizing portion 13a judges that reading of the current document set is finished, and the page dividing portion 13b creates and stores one file from a document set which is not filed up to one sheet before in the same manner as steps S36 and S37 (steps S48 and S49).

In the case of YES at step S46, in the case of NO at step S47, and after step S49, the UI image 70 of FIG. 7A is displayed (step S50). The control portion 10 judges whether or not the finish reading key 71 is selected (step S51), and in the case of NO, judges whether or not the start key 64 is selected (step S52). In the case of NO at step S52, the procedure returns to step S51. Note that, in the present processing example, it is premised that reading is performed at a time, and description is given for reading from the document platen by regarding a series of reading until the finish reading key 71 is selected as reading at a time.

In the case of YES at step S52, which means that the user has placed the next document on the document platen and pressed the start key 64, the control portion 10 returns to step S44 to execute similar size detection and document reading processing for the document. In the case of YES at step S51, since reading of the document bundle composed of all document sets is finished, one file is created from a document set which is not filed, serving as a document set after size change is performed finally, by returning to step S39.

In this manner, as to the reading processing from the document platen, document reading processing of the document set is continued by pressing of the start key 64 until size change is detected, and after filing at a stage where size change is performed, processing for reading and filing a next document set is executed. Then, the processing for reading and filing the document set is executed until the finish reading key 71 is pressed.

As described above, in the present processing example, filing is performed for each document size and one electronic mail with all files attached is transmitted finally. For example, when a document bundle composed of two copies (two sets) of document sets in total, including a document set composed of three sheets of documents with an A4 size and a document set composed of two sheets of documents with a B4 size, is regarded as a transmission target, only by reading these two sets at a time, two files in total, including a file composed of three pages with the A4 size and a file composed of two pages with a B4 size, are to be generated and transmitted by attaching to one electronic mail.

### Third Processing Example

Description will be given for a third processing example in the MFP 1a according to the present embodiment. The present processing example is characterized in that a document bundle composed of plural document sets corresponding to each of plural files to be attached is read by the document reading portion 12 basically at a time and placement directions of documents are differentiated. Description will be given below for the present processing example, but description for same points as the first and second processing example will be omitted.

In the present processing example, the above user designation is designation by changing a placement direction (vertical direction/lateral direction) of a document in the consecutive document sets. When the MFP 1a is set to the plural-file transmission mode, the section recognizing portion 13a then causes the document reading portion 12 to read the document bundle successively to obtain image data, detects a difference between placement directions from the image data, and recognizes a site where the placement direction difference occurs as a page section. The page dividing portion 13b divides the image data obtained by reading of the document bundle at the document reading portion 12 based on the page section recognized by the section recognizing portion 13a, and generates plural files so as to correspond to the plural document sets respectively included in the document bundle.

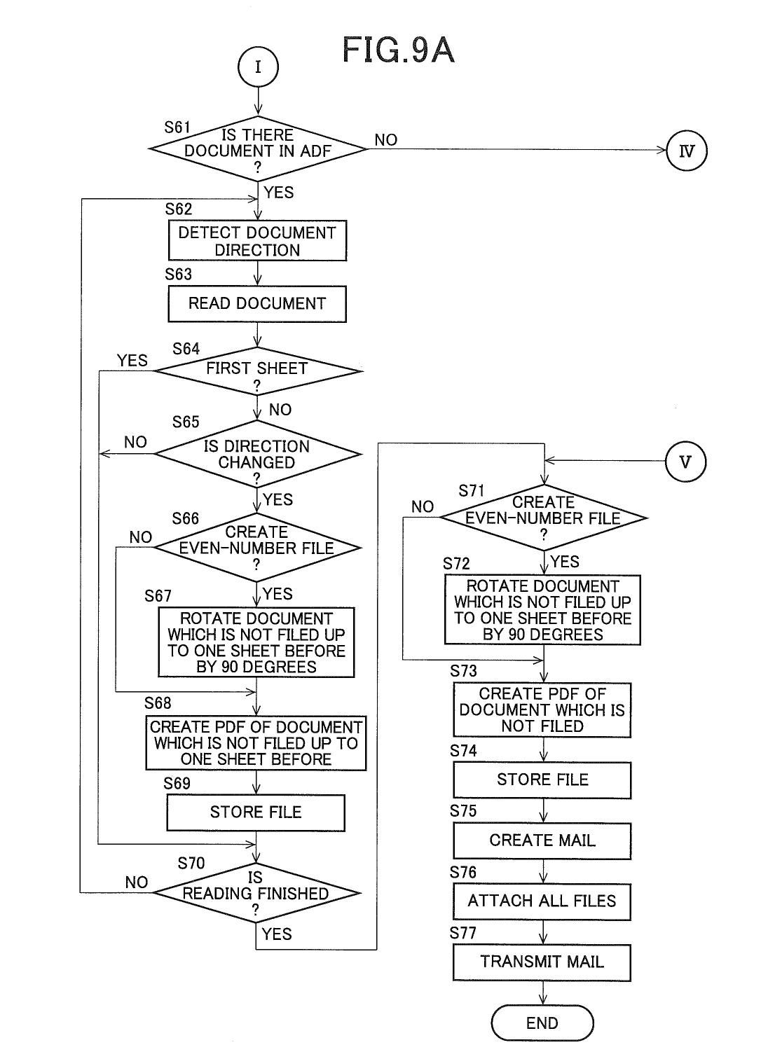

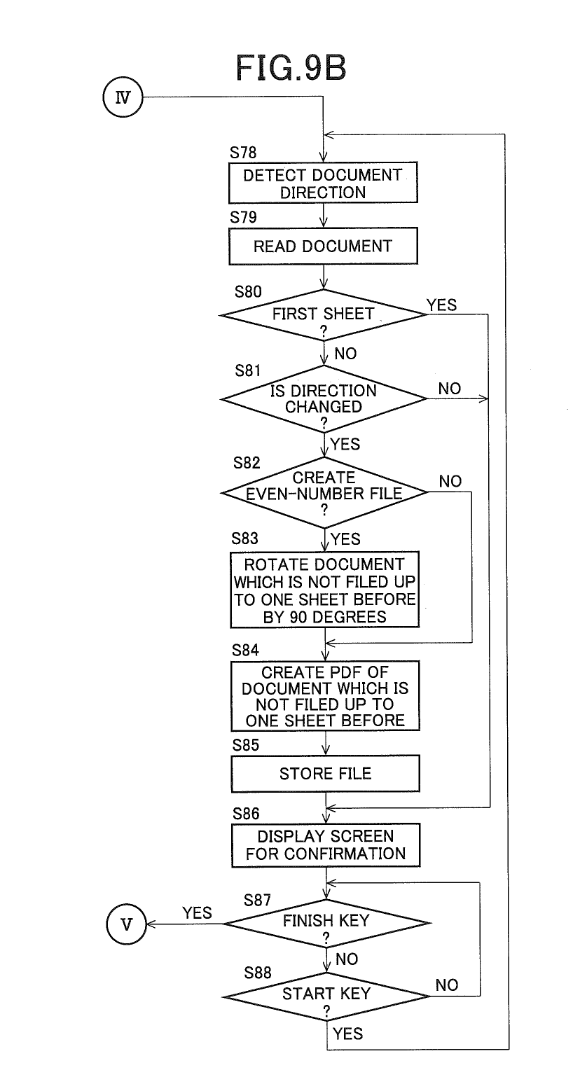

The present processing example will be described with a case where the Scan to E-mail function is used with reference to FIG. 9A and FIG. 9B in combination. FIG. 9A is a flowchart of the present processing example subsequent to FIG. 4, and FIG. 9B is a flowchart subsequent to FIG. 9A. In the present processing example, in the case of YES at step S3 of FIG. 4, processing of FIG. 9A is executed.

First, the control portion 10 judges whether or not there is a document in the ADF based on a detection result from the not-shown document detection sensor (step S61), and in the case of YES, detects a placement direction of the document (step S62). Step S62 is able to be realized by arranging plural document detection sensors in place. Subsequently, the control portion 10 causes the document reading portion 12 to execute document reading processing while carrying the document by the ADF automatically (step S63).

Then, the section recognizing portion 13a judges whether or not to be a first document sheet (step S64), and in the case of YES, moves to step S70. At step S70, based on a detection result from the document detection sensor, the document reading portion 12 judges whether or not all reading is finished. In the case of NO at step S70, the procedure returns to step S62. In the case of NO at step S64, the section recognizing portion 13a judges whether or not direction change is performed based on the detection result at step S62 (step S65), and in the case of NO here, the procedure moves to step S70.

In the case of YES at step S65, the section recognizing portion 13a judges that reading of the current document set is finished. Then, the page dividing portion 13b judges whether or not to create an even-number file (that is, a file obtained by reading an even-numbered document set) (step S66). Here, when direction change occurs odd number of times from the judgment result at step S65, the judgment may be made as creating the even-number file.

In the case of YES at step S66, which means that the user has placed the laterally long document set aiming that a section is recognized, the page dividing portion 13b rotates image data of a document set which is not filed up to one sheet before by 90 degrees (step S67), and then, creates one file (such as PDF) from the image data (step S68) for storing (step S69). After step S69, the procedure moves to step S70.

Note that, description is given on the premise that a first document set is vertically long, but it is possible to cope with even a laterally long one by making a change so that whether or not to create an odd-number file at step S66 and steps S71 and S82 which are described below is judged, etc. Further, also when there is no rule as to whether the first is vertically long or laterally long, a placement direction of a first document set may be judged upon a document size detection result, and processing may be changed based on a judgment result thereof.

In the case of YES at step S70, the page dividing portion 13b creates one file from image data which is not filed at the time (step S73) for storing (step S74). However, in this case as well, prior to step S73, rotation by 90 degrees is carried out as necessary by the processing similar to steps S66 and S67 (steps S71 and S72).

Subsequently, the transmission processing portion 13 creates one electronic mail to the destination which is set at step S2 (step S75), attaches all files which are stored to the electronic mail (step S76), performs transmission of the electronic mail via the communication portion 14 (step S77), and finishes the processing. Note that, if never going through the case where YES is given at step S65 or step S81 which is described below, only one file is to be attached and transmitted even in the plural-file transmission mode at step S76.

Note that, when a UI image for confirming whether or not reading is finished (reading of a next document set is performed) like the UI image 70 of FIG. 7A is to be displayed immediately after the case of YES at step S70, it is possible to perform reading by the ADF separately plural times like in the first processing example. In this case, a target to be read at a time each time the start key 64 is pressed may be a document set group which is accompanied by direction change or one document set which is not accompanied by direction change.

In the case of NO at step S61, which means that a document is placed on the document platen, the processing on the document platen is performed instead of the processing in the ADF. First, the control portion 10 detects a placement direction of the document on the document platen (step S78), and causes the document reading portion 12 to read the document (step S79).

Subsequently, processing similar to steps S64 to S69 (but, reading is performed on the document platen) is executed (steps S78 to S85). In the case of YES at step S80, in the case of NO at step S81, and after step S85, the UI image 70 of FIG. 7A is displayed (step S86). The control portion 10 judges whether or not the finish reading key 71 is selected (step S87), and in the case of NO, judges whether or not the start key 64 is selected (step S88). In the case of NO at step S88, the procedure returns to step S87. Note that, it is premised here that reading is performed at a time, and description is given for reading from the document platen by regarding a series of reading until the finish reading key 71 is selected as reading at a time.

In the case of YES at step S88, which means that the user has placed a next document on the document platen and pressed the start key 64, the control portion 10 returns to step S78 to execute similar direction detection and document reading processing for the document. In the case of YES at step S87, reading of a document bundle composed of all document sets is finished, and therefore the procedure may move to step S71.

In this manner, as to the reading processing from the document platen, document reading processing of the document set is continued by pressing of the start key 64 until placement direction change is detected, and after filing at a stage where placement direction change is performed, processing for reading and filing a next document set is executed. Then, the processing for reading and filing the document set is executed until the finish reading key 71 is pressed.

As described above, in the present processing example, filing is performed for each placement direction, and one electronic mail with all files attached is transmitted finally. For example, when it is desired to perform chapter section of documents with the A4 size into three sheets and five sheets, the placement direction may be changed in a boundary therebetween, a document bundle composed of two copies (two sets) of document sets in total, including a document set composed of three sheets of documents with the A4 size and a document set composed of five sheets of documents with an A4R size (laterally long documents with the A4 size), may be regarded as a transmission target, and these two sets may be read at a time with their vertical and lateral directions remained. Thereby, two files in total, including a file composed of three pages with the A4 size and a file composed of five pages with the A4 size, are to be generated and transmitted by attaching to one electronic mail.

### Fourth Processing Example

Description will be given for a fourth processing example in the MFP 1a according to the present embodiment. The present processing example is characterized in that a document bundle composed of plural document sets corresponding to each of plural files to be attached is read by the document reading portion 12 basically at a time and the number of sets of the document sets and the number of pages of each document set are input by the user. Though description will be given below for the present processing example, description for same points as the first to third processing examples will be omitted.

The MFP 1a in the present processing example includes a display portion that displays, when the MFP 1a is set to the plural-file transmission mode, a UI image for causing the user to input the number of sets of the document sets included in the document bundle and the number of pages of each document set (referred to as a second UI image for convenience). This display portion is able to be exemplified by the display portion in the touch panel portion 11b. Further, the above user designation in the present processing example is designation by inputting the above number of sets and the above number of pages in a state where the second UI image is displayed, and the section recognizing portion 13a recognizes a section subjected to the user designation. The page dividing portion 13b divides image data obtained by reading of the document bundle at the document reading portion 12 based on the page section recognized by the section recognizing portion 13a, and generates plural files so as to correspond to plural document sets respectively included in the document bundle.

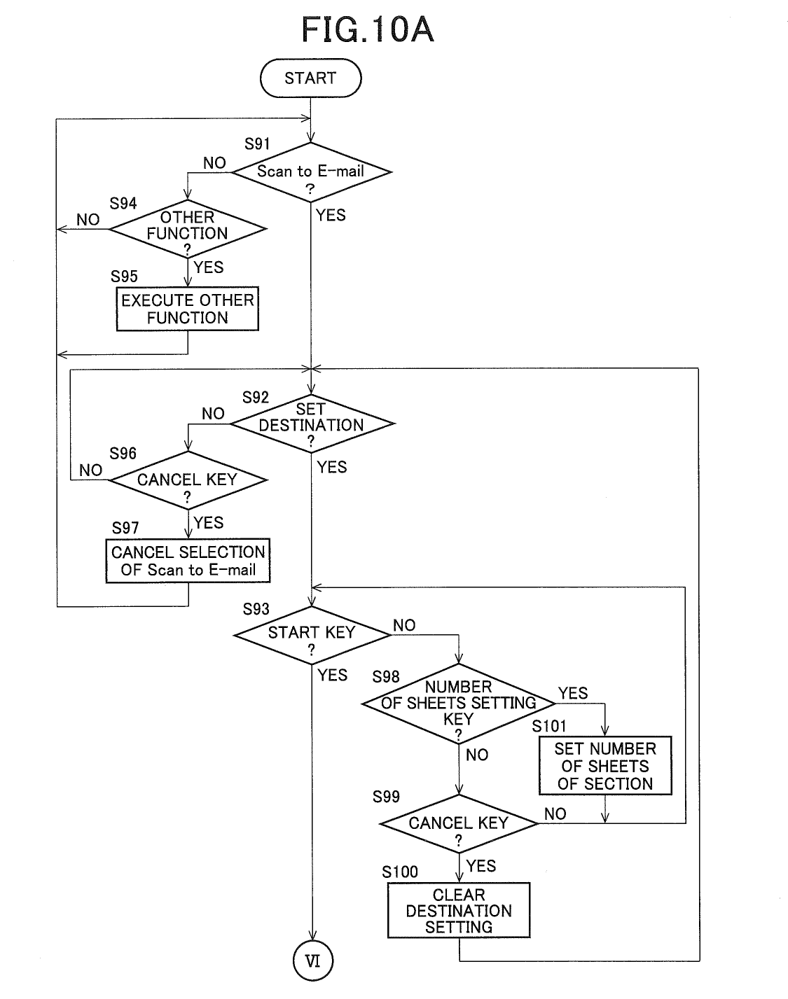

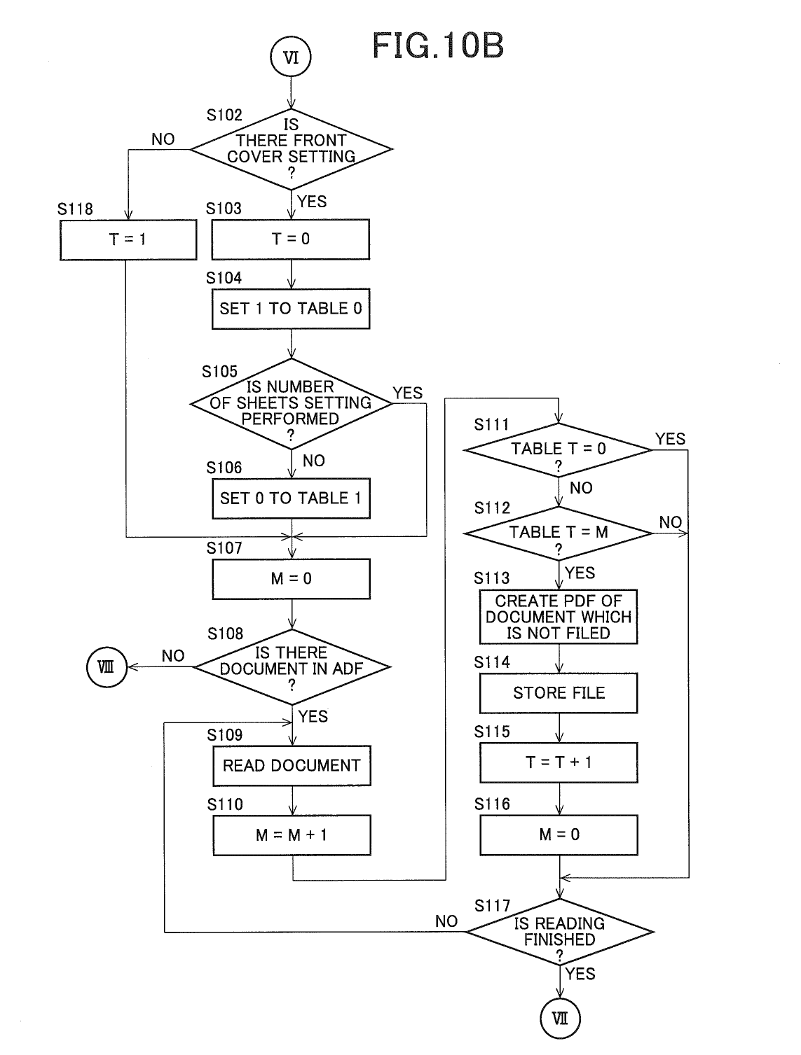

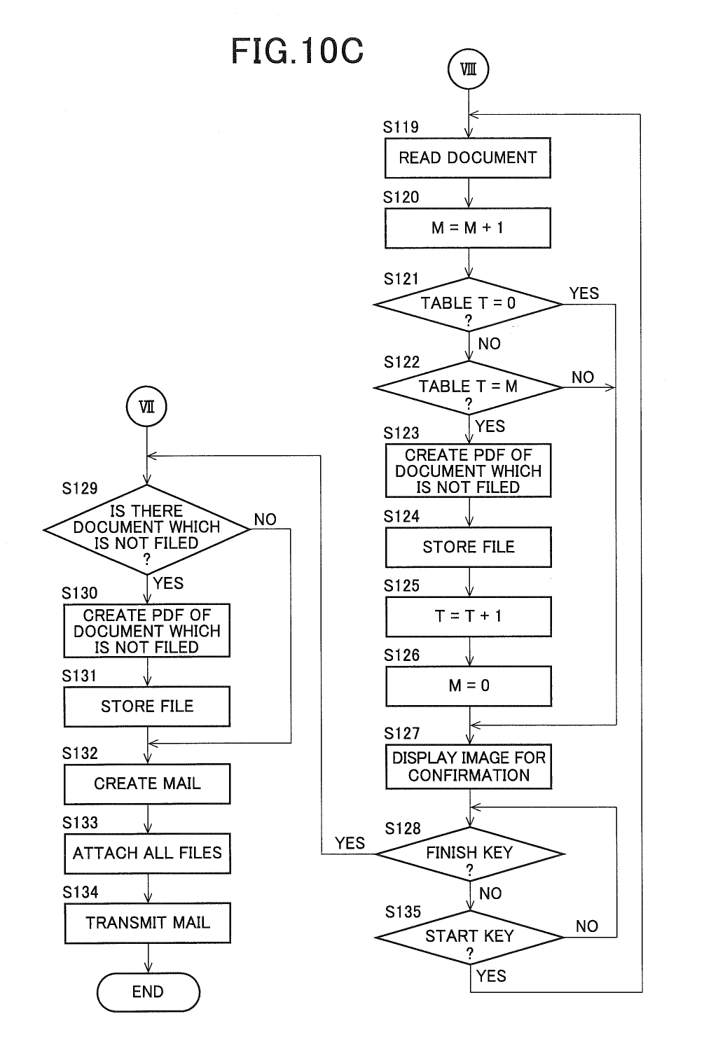

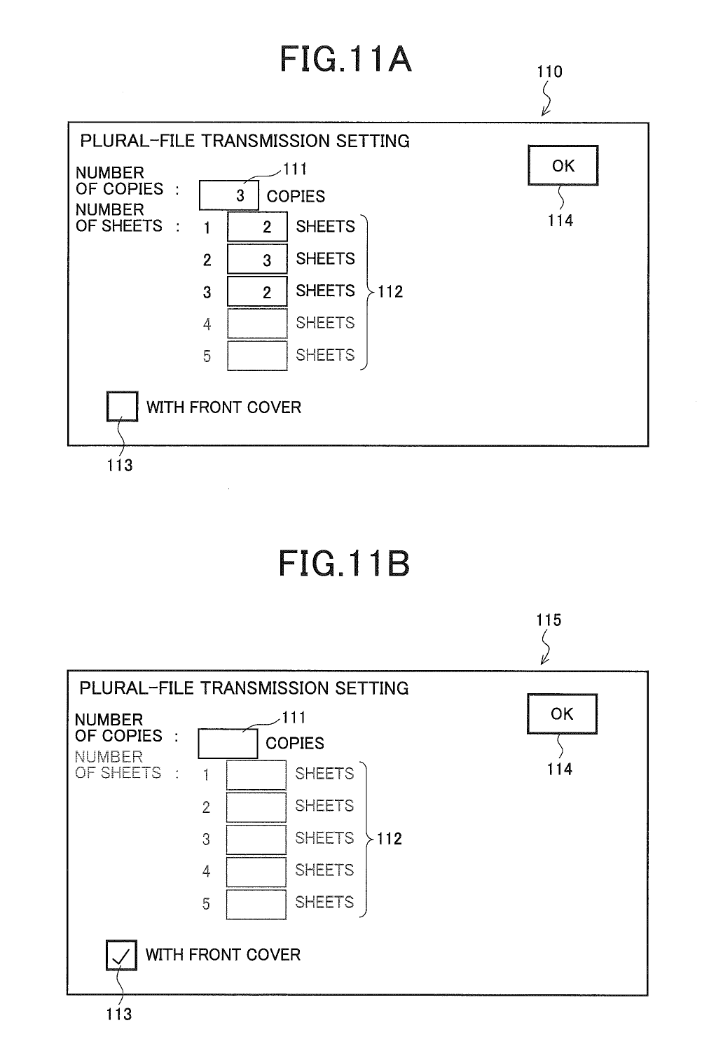

The present processing example will be described with a case where the Scan to E-mail function is used with reference to FIG. 10A to FIG. 11B in combination. FIG. 10A is a flowchart for explaining the fourth processing example executed with the Scan to E-mail function in the MFP of FIG. 3, FIG. 10B is a flowchart subsequent to FIG. 10A, and FIG. 10C is a flowchart subsequent to FIG. 10B. Further, FIG. 11A is a view showing one example of a UI image which is displayed when the plural-file transmit key is selected in the UI image of FIG. 6B, and FIG. 11B is a view showing an input example different from FIG. 11A.

First, processing similar to steps S1 to S7 of FIG. 4 is executed (steps S91 to S97). In the case of NO at step S93, the setting portion 10a judges whether or not a number of sheets setting key is selected (step S98).

The number of sheets setting key may be a key which is included in the UI image displayed when the plural-file transmit key 68 is selected in the UI image 67 of FIG. 6B or the plural-file transmit key 68 itself, for example. Without limitation thereto, a UI image allowing setting of the number of sheets of each document set (such as a UI image 110 of FIG. 11A) may be displayed by any operation.

Here, description will be given for an example that the above number of sheets setting key is the plural-file transmit key 68 itself. When the plural-file transmit key 68 is selected by the user (in the case of YES at step S98), the setting portion 10a sets the MFP 1a to the plural-file transmission mode as well as displays the UI image 110.

In the UI image 110, a number of sets input field 111 and a number of sheets input field 112 are displayed as well as an OK key 114 is also displayed. The number of sets input field 111 is a field for receiving user input of the number of sets (number of copies), and the number of sheets input field 112 becomes in a state allowing inputting only by a number of a numerical value which is input as the number of sets. In this example, “3” is input as the number of sets, resulting that fields for first to third sets in the number of sheets input field 112 allow inputting. In addition, a check box 113 for setting whether or not to attach a front cover (invoice) in which a model sentence is described is also displayed in the UI image 110. Note that, the above model sentence normally includes data of a name of a destination which is caused to be read from an address book or the like.

When the OK key 114 is selected by the user, the setting portion 10a completes setting of the number of sheets for a section, that is, setting of the number of sets and the number of sheets in accordance with information input from the UI image 110 (step S101). Further, when a front cover is selected by selection of the check box 113, the front cover is calculated as one document set, and therefore the number of copies (number of sets) may not be input as exemplified in a UI image 115 of FIG. 11B.

In the case of NO at step S98, the control portion 10 judges whether or not the cancel key (reset key 65) is selected (step S99). In the case of NO at step S99 and after step S101, the control portion 10 returns to step S93 to wait for pressing of the start key 64, while in the case of YES at step S99, clears destination setting (step S100) and returns to step S92.

In the case of YES at step S93, the procedure moves to processing of FIG. 10B and FIG. 10C. First, the section recognizing portion 13a judges whether or not there is front cover setting from setting content (step S102). When there is front cover setting (in the case of YES), the section recognizing portion 13a sets a variable number T to 0 (step S103) and sets 1 to a table 0 (step S104). Here, the variable number T is a variable number which indicates a number of a table, and the table is a storage area of a value which is set as the number of sheets of a document set. One sheet is set as the front cover at step S104.

After step S104, the section recognizing portion 13a judges whether or not setting of the number of sheets is performed for the table 0 from the setting content (step S105), and in the case of NO, the document set other than the front cover is one, and therefore 0 is set to a table 1 (step S106). In the case of NO at step S102 (in the case of no front cover), the variable number T is set as 1 (step S118). After step S106, after step S118, and in the case of YES at step S105, the section recognizing portion 13a initializes a variable number M into 0 (step S107). Here, the variable number M is a count value of the number of sheets which are read.

After step S107, the control portion 10 judges whether or not there is a document in the ADF based on a detection result from the not-shown document detection sensor (step S108), and in the case of YES, causes the document reading portion 12 to execute document reading processing while conveying the document by the ADF automatically (step S109).

Subsequently, the section recognizing portion 13a increments the variable number M (step S110) and judges whether or not a value of a table T is 0 (step S111), and in the case of NO, judges whether or not the value of the table T is M (step S112). In the case of YES at step S112, which means that the document set reaches a set number of sheets, the page dividing portion 13b creates one file from image data which is not filed at the time (step S113) for storing (step S114). Thereafter, in order to move to processing of a next table (processing of a next document set), the section recognizing portion 13a increments the variable number T (step S115), and initializes the variable number M into 0 (step S116).

After step S116, in the case of YES at step S111, and in the case of NO at step S112, the procedure moves to step S117. At step S117, the document reading portion 12 judges whether or not all reading is finished based on a detection result from the document detection sensor, and in the case of NO, the procedure returns to step S109.

In the case of YES at step S117, the page dividing portion 13b judges whether or not there is image data which is not filed at the time (step S129), and in the case of YES, creates one file from the image data (step S130) for storing (step S131). When there is a front cover and there is no setting for the number of sheets of the document set, YES is given at step S129.

After step S131 and in the case of NO at step S129, the transmission processing portion 13 creates one electronic mail to the destination which is set at step S92 (step S132), attaches all files which are stored to the electronic mail (step S133), performs transmission of the electronic mail via the communication portion 14 (step S134), and finishes the processing. Note that, in the case of NO at step S102 and when NO has never be given at step S117 after the storage processing at step S114, etc., only one file is to be attached and transmitted even in the plural-file transmission mode at step S133.

Note that, when a UI image for confirming whether or not reading is finished (reading of a next document set is performed) like the UI image 70 of FIG. 7A is to be displayed immediately after the case of YES at step S117, it is possible to perform reading by the ADF separately plural times like in the first processing example.

In the case of NO at step S108, which means that a document is placed on the document platen, processing on the document platen is performed instead of processing in the ADF. First, the control portion 10 causes the document reading portion 12 to read the document on the document platen (step S119).

Subsequently, processing similar to steps S110 to S116 (but, reading is performed on the document platen) is executed (steps S120 to S126). After step S126, in the case of YES at step S121, and in the case of NO at step S122, the UI image 70 of FIG. 7A is displayed (step S127). The control portion 10 judges whether or not the finish reading key 71 is selected (step S128), and in the case of NO, judges whether or not the start key 64 is selected (step S135). In the case of NO at step S135, the procedure returns to step S128. Note that, it is premised here that reading is performed at a time, and description is given for reading from the document platen by regarding a series of reading until the finish reading key 71 is selected as reading at a time.

In the case of YES at step S135, which means that the user has placed a next document on the document platen and pressed the start key 64, the control portion 10 returns to step S119 to execute similar document reading processing for the document. In the case of YES at step S128, reading of a document bundle composed of all document sets is finished, and therefore the procedure may move to step S129.

In this manner, as to the reading processing from the document platen, document reading processing of the document set is continued by pressing of the start key 64 until the section shown by setting content is reached, and after filing at a stage where the section has passed, processing for reading and filing a next document set is executed. Then, the processing for reading and filing the document set is to be continued until the finish reading key 71 is pressed.

As described above, in the present processing example, filing is performed for each document set in accordance with setting content, and one electronic mail with all files attached is transmitted finally. To explain with a setting example shown by the UI image 110 of FIG. 11A, when a document bundle composed of three copies (three sets) of document sets in total, including a document set composed of two sheets of documents, a document set composed of three sheets of documents, and a document set composed of two sheets of documents, is regarded as a transmission target, only by reading these three sets at a time as they are (by placing one by one in the case of the document platen), three files in total corresponding to each of the document sets are to be generated and transmitted by attaching to one electronic mail. When a front cover is attached, one file corresponding to a document set for the front cover is to be further attached.

Note that, when the actual number of sheets of the document reading result is not matched with the number of sets or the number of sheets of each set, which is set, the processing itself may be canceled to notify the user of that effect or a change request message may be given to cause the user to add a document or change setting content.

### Fifth Processing Example

Description will be given for a fifth processing example in the MFP 1a according to the present embodiment. The present processing example is characterized in that a document bundle composed of plural document sets corresponding to each of plural files to be attached is read by the document reading portion 12 basically at a time and a color sheet is inserted between document sheets. Though description will be given below for the present processing example, description for same points as the first to fourth processing examples will be omitted.

In the present processing example, the above user designation is designation by putting (inserting) a predetermined-color sheet (sheet on which nothing is printed) between document sets additionally. Further, when the MFP 1a is set to the plural-file transmission mode, the section recognizing portion 13a causes the document reading portion 12 to read a document bundle successively to obtain image data, detects the above predetermined-color sheet from the image data, and recognizes a position of the above predetermined-color sheet as a page section. The page dividing portion 13b divides the image data obtained by reading of the document bundle at the document reading portion 12 based on the page section recognized by the section recognizing portion 13a, and generates plural files so as to correspond to the plural document sets respectively included in the document bundle. However, image data of the above predetermined-color sheet is deleted among the image data which is read.

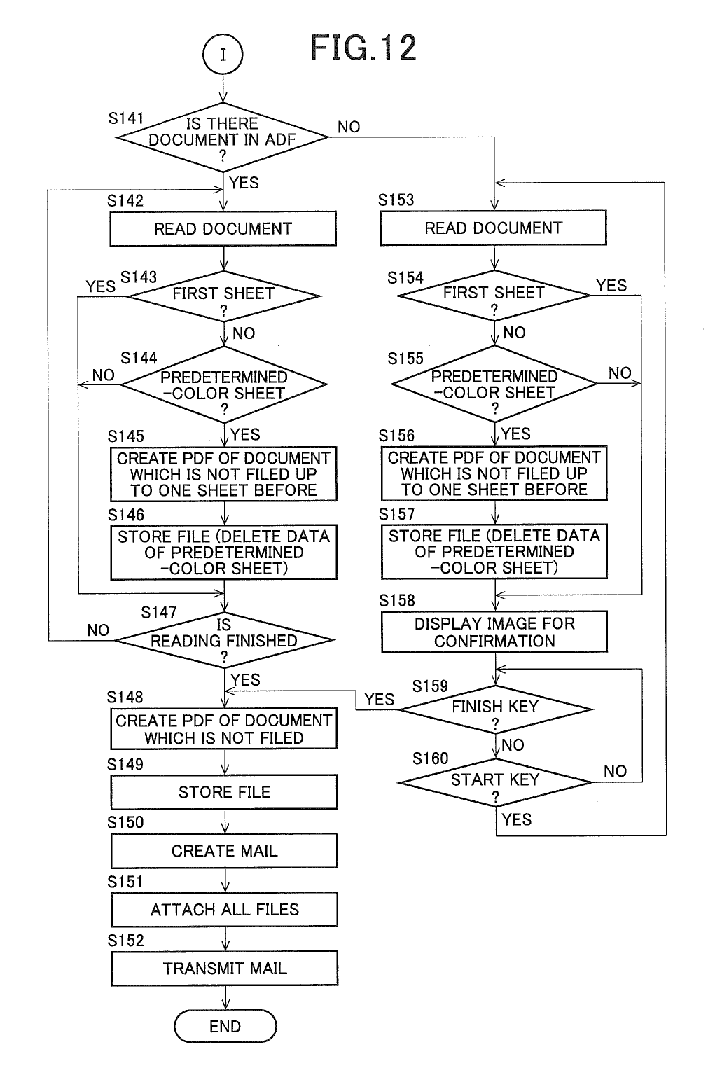

The present processing example will be described with a case where the Scan to E-mail function is used with reference to FIG. 12 in combination. FIG. 12 is a flowchart of the present processing example subsequent to FIG. 4. In the present processing example, in the case of YES at step S3 of FIG. 4, processing of FIG. 12 is executed.

First, the control portion 10 judges whether or not there is a document in the ADF based on a detection result from the not-shown document detection sensor (step S141), and in the case of YES, causes the document reading portion 12 to execute document reading processing while conveying the document by the ADF automatically (step S142).

Then, the section recognizing portion 13a judges whether or not to be a first document sheet (step S143), and in the case of YES, moves to step S147. At step S147, based on a detection result from the document detection sensor, the document reading portion 12 judges whether or not all reading is finished. In the case of NO at step S147, the procedure returns to step S142. In the case of NO at step S143, the section recognizing portion 13a detects a color of image data which is read over a page thereof, and based on a result thereof judges whether or not to be a predetermined color which is set in advance over the entire page (step S144), and in the case of NO, the procedure moves to step S147.

In the case of YES at step S144, the section recognizing portion 13a judges that reading of the current document set is finished. Then, the page dividing portion 13b creates one file (such as PDF) from image data of a document set which is not filed up to one sheet before (step S145) for storing (step S146). However, at a stage of step S146 or a stage of step S145, the image data of the predetermined-color sheet causing judgment as YES at step S144 is deleted. After step S146, the procedure moves to step S147.

In the case of YES at step S147, the page dividing portion 13b creates one file from the image data which is not filed at the time (step S148) for storing (step S149). Note that, though description is given on the premise that a predetermined color is not put in a first or last sheet of the document bundle, description is able to be given with a same concept by changing a processing flow even in the case of putting it in the first and/or the last.

Subsequently, the transmission processing portion 13 creates one electronic mail to the destination which is set at step S2 (step S150), attaches all files which are stored to the electronic mail (step S151), performs transmission of the electronic mail via the communication portion 14 (step S152), and finishes the processing. Note that, if never going through the case where YES is given at step S144 or step S155 which is described below, only one file is to be attached and transmitted even in the plural-file transmission mode at step S151.

Note that, when a UI image for confirming whether or not reading is finished (reading of a next document set is performed) like the UI image 70 of FIG. 7A is to be displayed immediately after the case of YES at step S147, it is possible to perform reading by the ADF separately plural times like in the first processing example. In this case, a predetermined-color sheet may be put at least in the last in a target to be read at a time each time the start key 64 is pressed.

In the case of NO at step S141, which means that a document is placed on the document platen, processing on the document platen is performed instead of processing in the ADF. First, the control portion 10 causes the document reading portion 12 to read the document on the document platen (step S153).

Subsequently, processing similar to steps S143 to S146 (but, reading is performed on the document platen) is executed (steps S154 to S157). In the case of YES at step S154, in the case of NO at step S155, and after step S157, the UI image 70 of FIG. 7A is displayed (step S158). The control portion 10 judges whether or not the finish reading key 71 is selected (step S159), and in the case of NO, judges whether or not the start key 64 is selected (step S160). In the case of NO at step S160, the procedure returns to step S159. Note that, it is premised here that reading is performed at a time, and description is given for reading from the document platen by regarding a series of reading until the finish reading key 71 is selected as reading at a time.

In the case of YES at step S160, which means that the user has placed a next document on the document platen and pressed the start key 64, the control portion 10 returns to step S153 to execute similar direction detection and document reading processing for the document. In the case of YES at step S159, reading of a document bundle composed of all document sets is finished, and therefore the procedure may move to step S148.

In this manner, as to the reading processing from the document platen, document reading processing of the document set is continued by pressing of the start key 64 until the predetermined-color sheet is detected, and after filing at a stage where the predetermined-color sheet is detected, processing for reading and filing a next document set is executed. Then, the processing for reading and filing the document set is to be continued until the finish reading key 71 is pressed.

As described above, in the present processing example, filing is performed for each document set, and one electronic mail with all files attached is transmitted finally. For example, when a document bundle composed of three copies (three sets) of document sets in total, including a document set composed of two sheets of documents, a document set composed of three sheets of documents, and a document set composed of two sheets of documents, is regarded as a transmission target, only by reading the three sets at a time as they are (by placing one by one in the case of the document platen) in a state where predetermined-color (for example, pink or yellow) sheets are put at two sites in total between these document sets, three files in total corresponding to each of the document sets are to be generated and transmitted by attaching to one electronic mail.

### Third Embodiment

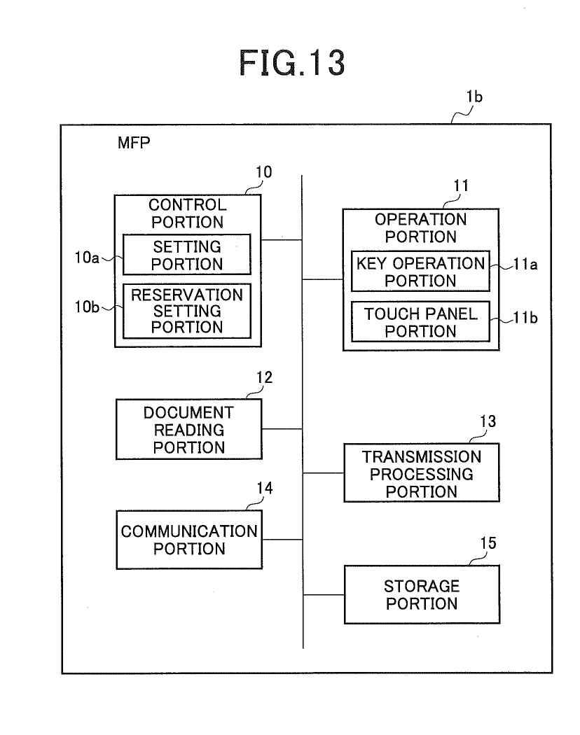

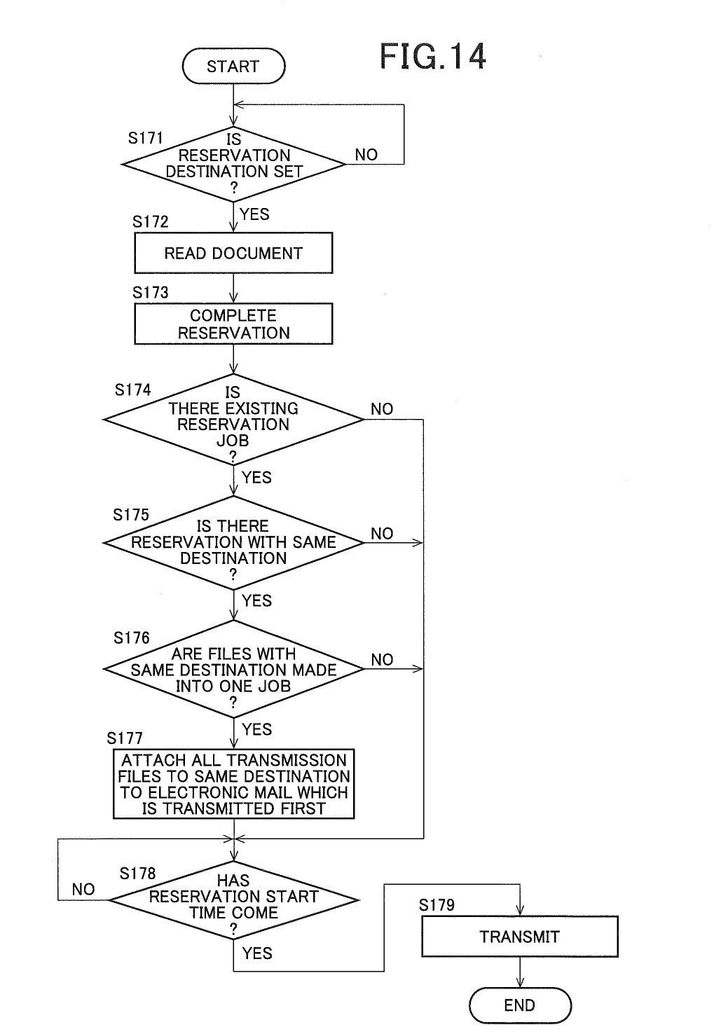

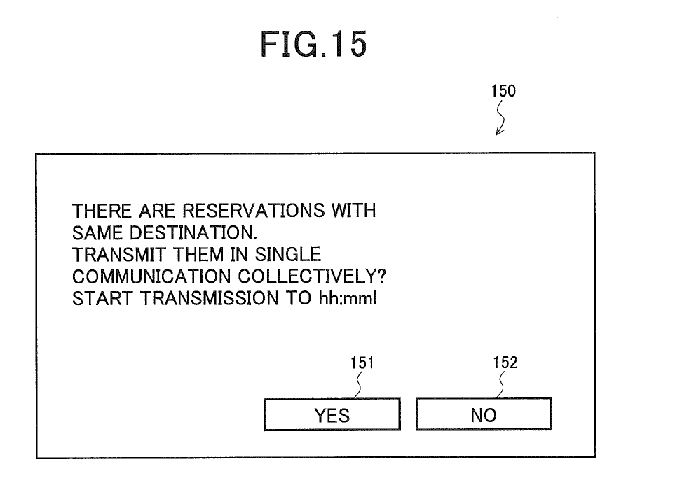

Description will be given for a third embodiment of the present invention with reference to FIG. 13 to FIG. 15. FIG. 13 is a block diagram showing one configuration example of an MFP according to the present embodiment, FIG. 14 is a flowchart for explaining a processing example executed with the Internet FAX function in the MFP of FIG. 13, and FIG. 15 is a view showing one example of a UI image which is displayed in the processing of FIG. 14 in the MFP of FIG. 13.

The MFP according to the third embodiment of the present invention is specialized in that at least one of plural document sets corresponding to each of plural files to be attached in the first embodiment is read by the document reading portion 12 at a different timing and is subjected to transmission reservation. Description will be given below for the present embodiment, but description for same points as the first and second embodiments will be omitted.

As exemplified in FIG. 13, in an MFP 1b according to the present embodiment, the control portion 10 in the MFP 1 of FIG. 1 has not only the setting portion 10a but a reservation setting portion 10b. The reservation setting portion 10b may be provided outside the control portion 10. The reservation setting portion 10b sets a reservation of time and date when executing transmission processing that one or plural files obtained by reading at the document reading portion 12 are attached to an electronic mail to be transmitted by the transmission processing portion 13 and the communication portion 14. This reservation setting may be performed by user operation from the operation portion 11 or an external PC which is separately connected. A file for which the reservation is set by the reservation setting portion 10b may be stored in a storage portion 15 provided in the MFP 1b.

Further, when the MFP 1b is set to the plural-file transmission mode and when a different file obtained by reading at the document reading portion 12 is transmitted to a destination same as a destination of the transmission-reserved file which is the file serving as a target of the above transmission processing, the transmission processing portion 13 transmits the above transmission-reserved file and the above different file by attaching to one electronic mail.

Accordingly, in the present embodiment, at least two or more files of one or plural files which are currently read and one or plural files which are reserved are to be attached to one electronic mail. Moreover, a file of a document set serving as any of a reservation target and a non-reservation target (reading target without reservation) may be obtained by the processing in the first and second embodiments.

In addition, it is preferable that transmission of the above one electronic mail at the transmission processing portion 13 is also able to be reserved, in other words, transmission of the above different file is also able to be reserved. That is, the transmission processing portion 13 is to transmit the above transmission-reserved file and the above different file by attaching to one electronic mail finally, but it is preferable that transmission time and date of the above one electronic mail is able to be set by the reservation setting portion 10b.

This transmission time and date may be designated by the user at a time when the above different file is read, or may be time and date when the above transmission-reserved file is scheduled to be transmitted. However, when the user sets a reservation for the above different file, it is assumed that there exist two or more time and date including the above transmission-reserved file, it is preferable to perform automatic setting so that the earliest time and date is set among the plural ones.

Next, description will be given for such a processing example with reference to FIG. 14 in combination.

First, for example, a UI image which includes a not-shown reservation setting key is displayed so that inputting of a destination and pressing of the reservation setting key are able to be received. In this state, the control portion 10 which includes the reservation setting portion 10b judges whether or not setting of transmission reservation is performed with the E-mail function or the Internet FAX function depending on whether or not inputting of a destination is received with pressing of the reservation setting key (step S171). Only after a stage where YES is given at step S171, the document reading portion 12 executes document reading processing from the ADF or the document platen (step S172) and the reservation is completed at a time when the document reading processing is completed (step S173).

Subsequently, the reservation setting portion 10b judges whether or not there is an existing transmission-reserved file (reservation job) in the storage portion 15 (step S174), and in the case of YES, judges whether or not the reservation job has a destination same as the destination of the file read at step S172 (step S175).

In the case of YES at step S175, the reservation setting portion 10b displays a UI image for inquiries which is exemplified with a UI image 150 of FIG. 15, and makes an inquiry of whether or not to transmit the file with the same destination simultaneously with one electronic mail as one job (step S176). In the UI image 150, a “Yes” key 151 which is selected when simultaneous transmission is performed and a “No” key 152 which is selected when simultaneous transmission is not performed are displayed.

When the user selects the “Yes” key 151 and YES is given at step S176, the reservation setting portion 10b attaches all the files with the same destination to an electronic mail which is to be transmitted at an earliest time to thereby make into one job (step S177). The transmission processing portion 13 or the reservation setting portion 10b then judges whether or not a reservation start time (time and date) for the job has come (step S178), and the transmission processing portion 13 transmits the job, that is, transmits the electronic mail to which all the files with the same destination are attached only after YES is given (step S179).

On the other hand, in the case of NO at any of steps S174, S175 and S176, the procedure moves to step S178 without through step S177. Note that, since it is premised that the plural-file transmission mode is set, the inquiry and judgment processing at step S176 may not be performed, and the inquiry at step S176 may be made at all times so that the plural-file transmission mode is set at a time when the “Yes” key 151 is selected.

As one example, description will be given for a case where a job addressed to aaa@test which is scheduled to be transmitted at 10:50 and a job addressed to bbb@test which is scheduled to be transmitted at 11:00 exist as the existing reservation jobs as well as a case where a transmission reservation addressed to aaa@test which is scheduled to be transmitted at 11:10 (referred to as a reservation Y) is set at step S171. In this case, after reading a document thereof, when it is searched whether or not there is a reservation job with the same destination before registration of the reservation Y is formally completed (registered), one job with the same destination exists among existing jobs.

Thus, when the user selects the “Yes” key 151 and YES is given at step S176, the job for the reservation Y is deleted as well as the jobs addressed to aaa@test that are scheduled to be transmitted at 10:50, which are made into one job (to which an existing file and a currently read file are attached) and an original job addressed to bbb@test which is scheduled to be transmitted at 11:00 remain, and when a reservation start time of each of them has come, are subjected to Internet FAX transmission. On the other hand, when the user selects the “No” key 152 and NO is given at step S176, the job for the reservation Y (to which the existing file is attached), the original job addressed to bbb@test which is scheduled to be transmitted at 11:00, and the job addressed to aaa@test which is scheduled to be transmitted at 11:10 (to which the currently read file is attached) remain, and when a reservation start time of each of them has come, are subjected to Internet FAX transmission.

Note that, the same is also applied to a case where the above transmission reservation files (with the same destination) are originally accumulated in plural pieces, but in this case automatic setting may be performed so that the earliest time and date is automatically set for the above different file among the plural ones without reservation setting by the user or the above different file may be transmitted promptly at a time when reading of the above different file etc., is finished.

### Configuration Examples Common in First to Third Embodiments

Though description has been given by assuming that plural files to be transmitted are transmitted by attaching to one electronic mail in each of the above embodiments, the MFP according to the present invention may be merely capable of such processing. Accordingly, such configuration is also allowed that a transmitting method, for example, such as transmission with carbon copy or group mail transmission is adopted so as to transmit an electronic mail with the above plural files attached to many destinations. Further, setting to the plural-file transmission mode may be allowed to be executed from any display screen without limitation to the examples described above.

In addition, though description has been given that the control portion 10 in the MFP exemplified in FIG. 1, FIG. 3 and FIG. 13 is able to be mounted also as an integrated-circuit/IC chip set, the same is also applied to the transmission processing portion 13. That is, the control portion 10 and the transmission processing portion 13 are able to be realized, for example, by hardware such as a peripheral device including a microprocessor (or DSP: Digital Signal Processor), a memory, a bus and an interface and software (control program described above) that is executable on this hardware. Apart of the above hardware is able to be mounted as an integrated-circuit/IC chip set, and in such a case, the above software may be stored in this memory. In addition, all the respective constituent elements of the present invention may be constituted by hardware, and similarly in such a case as well, a part of the hardware may be also mounted as an integrated-circuit/IC chip set.

Further, an object of the present invention is achieved even by supplying a recording medium (non-temporal recording medium) having a program code of software for realizing functions in various embodiments described above recorded therein to the MFP and executing the program code by a computer such as a microprocessor or a DSP in the MFP. That is, the present invention may adopt a form as a program code or a computer-readable recording medium having the program code recorded therein. Examples of this recording medium include a variety of media such as an optical disk including a CD-ROM, a DVD-ROM or the like, a non-volatile semiconductor memory including a memory card or the like, a hard disk, etc. Moreover, the program code is also able to be executed by downloading from the Internet or executed by receiving from a broadcast wave.

Further, though description has been given above for the MFP according to the present invention, as the procedure of the processing thereof has been described, the present invention may adopt a form as a file transmitting method in the MFP which includes a document reading portion and a transmitting portion that transmits an electronic mail. This file transmitting method has a step that a setting portion of the MFP sets the MFP to a predetermined transmission mode based on user operation, and a step that, when the MFP is set to the predetermined transmission mode, the transmitting portion transmits plural files corresponding to plural document sets respectively, which are obtained by executing reading at the document reading portion for the plural document sets prepared by allowing the numbers of pages to be different individually by attaching to one electronic mail. Other application examples are as described for the MFP and description thereof will be omitted.

Note that, the above program code itself is, in other words, a program for causing a computer of a control portion of the MFP which includes a document reading portion and a transmitting portion that transmits an electronic mail to execute file transmission processing in this file transmitting method. Here, the above file transmission processing has a step of setting the MFP to a predetermined transmission mode based on user operation, and a step of, when the MFP is set to the above predetermined transmission mode, transmitting plural files corresponding to plural document sets respectively, which are obtained by executing reading at the document reading portion for the plural document sets prepared by allowing the numbers of pages to be different individually by attaching to one electronic mail. Other application examples are as described for the MFP and description thereof will be omitted.

As above, according to the present invention, in a multi-functional peripheral, even when the numbers of pages of plural document sets are different, it is possible to transmit plural files obtained by reading each of the plural document sets by a document reading portion to one destination by single communication.

1. A multi-functional peripheral, comprising a document reading portion, and a transmitting portion that transmits an electronic mail, wherein,
a setting portion that sets the multi-functional peripheral to a predetermined transmission mode based on user operation is further included,
the transmitting portion, when the multi-functional peripheral is set to the predetermined transmission mode, transmits plural files corresponding to plural document sets respectively which are obtained by executing reading at the document reading portion for the plural document sets prepared by allowing the numbers of pages to be different individually by attaching to one electronic mail.

2. The multi-functional peripheral according to claim 1, further comprising:
a section recognizing portion that, when the multi-functional peripheral is set to the predetermined transmission mode, recognizes a page section between the document sets which are subjected to user designation as to a document bundle composed of the plural document sets; and
a page dividing portion that generates the plural files so as to correspond to the plural document sets respectively based on the page section recognized by the section recognizing portion from image data obtained by reading of the document bundle at the document reading portion.

3. The multi-functional peripheral according to claim 2, further comprising:
a display portion that, when the multi-functional peripheral is set to the predetermined transmission mode, displays a user interface image for prompting reading of a next of the document sets for each reading of the document sets until reading of the document bundle is finished at the document reading portion, wherein
the user designation is a designation by performing reading operation after sectioning for each of the document sets in accordance with the user interface image.

4. The multi-functional peripheral according to claim 2, wherein
the user designation is a designation by changing sizes of document sheets between the document sets which are consecutive, and
when the multi-functional peripheral is set to the predetermined transmission mode, the section recognizing portion causes the document reading portion to read the document bundle successively to obtain the image data, detects a difference between the sizes from the image data, and recognizes a site where the difference between the sizes occurs as the page section.

5. The multi-functional peripheral according to claim 2, wherein
the user designation is a designation by changing placement directions of document sheets between the document sets which are consecutive, and
when the multi-functional peripheral is set to the predetermined transmission mode, the section recognizing portion causes the document reading portion to read the document bundle successively to obtain the image data, detects the placement directions from the image data, and recognizes a site where a difference between the placement directions occurs as the page section.

6. The multi-functional peripheral according to claim 2, further comprising:
a display portion that, when the multi-functional peripheral is set to the predetermined transmission mode, displays a user interface image for causing a user to input the number of sets of the document sets included in the document bundle and the number of pages of each of the document sets, wherein
the user designation is a designation by inputting the number of sets and the number of pages in a state where the user interface image is displayed.

7. The multi-functional peripheral according to claim 2, wherein
the user designation is a designation by putting a predetermined-color sheet additionally between the document sets, and
when the multi-functional peripheral is set to the predetermined transmission mode, the section recognizing portion causes the document reading portion to read the document bundle successively to obtain the image data, detects the predetermined-color sheet from the image data, and recognizes a position of the predetermined-color sheet as the page section.

8. The multi-functional peripheral according to claim 1, further comprising:
a reservation setting portion that sets a reservation of time and date when transmission processing for transmitting a file obtained by reading at the document reading portion by attaching to an electronic mail is executed by the transmitting portion, wherein
when the multi-functional peripheral is set to the predetermined transmission mode and when a different file obtained by reading at the document reading portion is transmitted to a destination same as a destination of a transmission-reserved file which is the file serving as a target of the transmission processing, the transmitting portion transmits the transmission-reserved file and the different file by attaching to the one electronic mail.

9. A file transmitting method in a multi-functional peripheral including a document reading portion and a transmitting portion that transmits an electronic mail, including:
a step that a setting portion of the multi-functional peripheral sets the multi-functional peripheral to a predetermined transmission mode based on user operation,
a step that, when the multi-functional peripheral is set to the predetermined transmission mode, the transmitting portion transmits plural files corresponding to plural document sets respectively which are obtained by executing reading at the document reading portion for the plural document sets prepared by allowing the numbers of pages to be different individually by attaching to one electronic mail.
